(19) United States
(12) Patent Application Publication
(10) Pub. No.: US 2026/0065615 A1
(43) Pub. Date: Mar. 5, 2026

(54) SYSTEMS AND METHODS FOR CONFIGURING MIDDLEWARE TO CONTROL A HAPTIC DEVICE USING A NEURAL NETWORK

(71) Applicant: Adeia Guides Inc., San Jose, CA (US)

(72) Inventors: Tatu V.J. Harviainen, Helsinki (FI); Tao Chen, Palo Alto, CA (US); Dhananjay Lal, Englewood, CO (US)

(21) Appl. No.: 18/819,830

(22) Filed: Aug. 29, 2024

(51) Int. Cl. G06T 19/20; G06F 3/01; G06T 13/40

(52) U.S. Cl. CPC G06T 19/20; G06F 3/016; G06T 13/40; G06T 2219/2004

(57) ABSTRACT

Systems and methods are provided for configuring middleware to control a haptic device using a neural network. A system generates for display, based on at least one generic UI element, a virtual object within an XR environment. The XR application is configured to run on a local device, wherein the XR application causes display of the XR environment. The system configures middleware to run on the local device, wherein the middleware is configured to control at least one haptic device using at least one neural network. Based on avatar movement detected in the XR environment near the virtual object, the system causes the middleware to input control data into the at least one neural network. The at least one neural network outputs the control data for controlling the at least one haptic device. The system controls, by the middleware, the at least one haptic device based on the control data.

### BACKGROUND

This disclosure related to systems and methods for configuring middleware to control a haptic device using a neural network.

### SUMMARY

For extended reality (XR) applications (e.g., augmented reality, virtual reality, or any combination thereof) to achieve an immersive illusion of virtual elements being present in the physical space (i.e., perceivable via multiple sensory capabilities that are synchronized with audio or visual stimuli), haptics feedback is an important output modality (e.g., because haptics allows for incorporating physical stimuli to the XR user). In some approaches, 3D user interfaces employed by the XR applications enable users to interact with the virtual elements directly by using body motions as an input. Combined with gesture recognition, XR applications that provide users the ability to directly manipulate virtual objects create a robust XR user interface. However, there are many different types of haptic devices, each with its own unique functions, sensors, actuators, capabilities, etc. There is a lack of a universal approach for managing the different types of haptic devices used for XR direct manipulation, gesture recognition, and haptic feedback that is holding back the rise of this kind of fully natural user interface.

There is a similar problem of not having tools for implementing haptic feedback features that work on all the different types of haptic devices regardless of their unique functions, sensors, actuators, and capabilities (i.e., device-agnostic tools). Haptic feedback is in general a lacking area needed for XR applications to achieve plausible fully immersive XR experiences. In some approaches, systems may attempt to implement basic haptic feedback technologies that would allow unobstructive and realistic tactile and kinesthetic feedback generation. However, the challenges of combining haptics and gesture recognition for natural user interface on a variety of unique client devices remain a problem, as different client devices comprise different functionalities, sensors, actuators, inputs and outputs, etc. There is a need for a generic approach for haptics-enhanced, gesture-based 3D user interfaces for XR applications, instead of each XR application implementing required features for all possible combinations of gesture detection and haptic feedback input and output technologies. Accordingly, there is a need for systems to adapt the XR interaction to allow a more immersive XR experience with XR environments given the client device capabilities in terms of gesture recognition and haptic feedback.

To address these problems, haptics-assisted, gesture-based user interface may be handled by a generic middleware component, as any single XR application may not be able to implement suitable gesture detection, user input, and output permutations needed to support all possible combinations of input and output technologies that the client device (e.g., local device and/or haptic device) may have. In some embodiments, an XR system generates for display a virtual object, within an XR environment, wherein the display is based on at least one generic user interface (UI) element. For example, the XR system generates for display a virtual light switch within the XR environment. In some implementations, the design of the XR environment is based at least in part on a design system providing for display, at a design device, a design user interface for creating the XR environment. In some embodiments, a design system receives a design user interface selection for placement of the at least one generic UI element in a location in the XR environment, wherein the at least one generic UI element represents a functionality of a real-world object. For example, the design system may receive a design user interface selection of a generic light switch representing the functionality of a real-world light switch. Such aspects allow an XR application running on the local device, using data from middleware of the local device, to select the most appropriate virtual object based on user inputs. Such aspects also eliminate the need for a UX designer to select a specific virtual object.

In some implementations, a backend system configures the XR application to run on a local device, wherein the XR application causes display of the XR environment. The local device may be a smartphone, a laptop computer, a desktop computer, an XR device, any other suitable client device, or any combination thereof. For example, the backend system configures an XR application (e.g., a video game XR application) to run on a laptop. In some embodiments, the backend system configures middleware to run on the local device, wherein the middleware is configured to control at least one haptic device using at least one neural network. Such aspects allow the XR application to be implemented on a client device, associated with at least one haptic device, regardless of the haptic capabilities of the at least one haptic device. In some embodiments, the XR system detects movement of an avatar in the XR environment by the XR application in a vicinity of the virtual object. The movement of the avatar in the XR environment may correspond to the movement of an XR user in the real-world environment.

In some implementations, based on the detecting movement of the avatar in the XR environment by the XR application in the vicinity of the virtual object, the middleware puts input data into the at least one neural network. In some embodiments, the input data comprises: (i) a time series of user pose data received from at least one sensor, (ii) a time series of orientation data of the avatar received from the XR application, and (iii) positioning data of the avatar with respect to the virtual object received from the XR application. The at least one sensor may be associated with the client device and/or at least one haptic device. For example, the XR application, via a haptic glove worn by an XR user associated with the XR environment, may detect the positions and changes of positions over a time period (e.g., a time series of user pose data) of the XR user's hand. In another example, the XR application detects the positions of the avatar and changes of positions (e.g., a time series of orientation data) within the XR environment. In another example, the XR application detects the position of the avatar relative to the virtual light switch.

In some implementations, the at least one neural network of the middleware outputs control data for controlling the at least one haptic device based at least in part on the input data. In some embodiments, an algorithm for determining the output control data is determined empirically. In some embodiments, determining the output control data includes use of machine learning, such as support vector machines (SVMs), multilayer perceptrons (MLPs), convolutional neural networks (CNNs), any other suitable machine learning algorithm, or any combination thereof. For example, based on the input data, the at least one neural network may output control data for controlling the haptic glove (e.g., instructions sent to the middleware for particular movements and vibrations of the haptic glove). In some embodiments, the middleware controls the at least one haptic device based on the control data. For example, the middleware controls a vibration of a finger of the haptic glove based on the control data output from the at least one neural network.

In some embodiments, the backend system pre-trains the at least one neural network for generating the control data based on at least one functional description of the at least one generic UI element. For example, at least one functional description of the generic light switch may be a state of the generic light switch, such as “On,” “Off,” or “Dimmer.” Such aspects provide the at least one neural network with a starting point from which to evolve. In some implementations, the backend system configures a plurality of XR applications to run on a plurality of local devices, wherein each XR application of the plurality of XR applications comprises the at least one generic UI element. For example, the plurality of XR applications may be a plurality of VR video games, each of which comprises a generic light switch element. Each XR application of the plurality of XR applications is configured to run on a plurality of devices (e.g., laptops, smartphones, a plurality of operating systems, etc.). In some embodiments, the backend system receives, from respective middleware of each local device of the plurality of local devices running the plurality of XR applications, user interaction data of a plurality of virtual objects corresponding to the at least one generic UI element.

For example, the backend system receives user interaction data (e.g., control data, implicit user feedback, explicit user feedback, any other suitable user interaction, or any combination thereof) from a plurality of XR applications, each of which comprises a specific virtual light switch. Each specific virtual light switch corresponds to the generic light switch. In some implementations, each XR application of the plurality of XR applications may comprise the same specific virtual light switch. The user interaction data may correspond to or be associated with a type(s) of sensor of the haptic device associated with the local device. For example, an advanced haptic glove may provide more detailed user feedback (e.g., detection of smaller finger movements) to the respective XR application while a rudimentary haptic glove may provide less detailed user feedback (e.g., detection of larger finger movements only) to the respective XR application. In some embodiments, the backend system re-trains the at least one neural network for generating the control data based on the received user interaction data. Such aspects allow the at least one neural network to learn from a plurality of data sources, thereby improving the accuracy of its future outputs.

In some implementations, the backend system determines, by the middleware, at least one of: (a) a type of sensor, or (b) a type of the at least one haptic device. For example, the system may determine that the at least one haptic device is a pair of HaptX gloves comprising hundreds of actuators (e.g., sensors). In another example, the system determines that the at least one haptic device is a remote control with haptics capabilities, comprising just a few sensors, such as rudimentary vibration motors. In some embodiments, the system transmits, to the XR application, data comprising the at least one of: (a) the type of sensor, or (b) the type of the at least one haptic device. For example, the backend system transmits identifiers of the type of sensor(s) or the type of the at least one haptic device to the XR application. The appearance of the virtual object may be selected by the XR application based at least in part on the at least one of: (a) the type of sensor, or (b) the type of the at least one haptic device. In some embodiments, the appearance of the virtual object selected by the XR application has functional and/or cosmetic effects on the virtual object. For example, based on receiving data indicating that the at least one haptic device is a pair of HaptX gloves with hundreds of actuators, the XR application may select an advanced virtual light switch to display in the XR environment. In another example, based on receiving data indicating that the at least one haptic device is a remote control with few sensors, the XR application may select a more rudimentary virtual light switch to display in the XR environment. Such aspects allow the XR application to provide an appropriate haptic feedback response to the at least one haptic device. An appropriate haptic feedback is essential to providing an immersive XR experience.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A depicts an illustrative example of designing an XR environment comprising a virtual object based on at least one generic UI element, in accordance with some embodiments of this disclosure.

FIG. 1B depicts an illustrative example of configuring middleware to control a haptic device using control data, in accordance with some embodiments of this disclosure.

FIG. 2 depicts an illustrative example of transmitting control data to a plurality of local devices and controlling a plurality of haptic devices, via a plurality of middleware modules, according to the control data, in accordance with some embodiments of this disclosure.

FIG. 3A depicts an illustrative example of selecting a virtual object based on a type of haptic device, in accordance with some embodiments of this disclosure.

FIG. 3B depicts an illustrative example of selecting a virtual object based on a type of haptic device, in accordance with some embodiments of this disclosure.

FIG. 3C depicts an illustrative example of selecting a virtual object based on a type of haptic device, in accordance with some embodiments of this disclosure.

FIG. 4A depicts an illustrative example of selecting a virtual object based on a type of haptic device, in accordance with some embodiments of this disclosure.

FIG. 4B depicts an illustrative example of selecting a virtual object based on a type of haptic device, in accordance with some embodiments of this disclosure.

FIG. 5 depicts an illustrative example of a multi-layer neural network for inferring UI element states and haptic feedback device control signals, in accordance with some embodiments of this disclosure.

FIG. 6 depicts an illustrative user equipment device, in accordance with some embodiments of this disclosure.

FIG. 7 depicts an illustrative user equipment device, in accordance with some embodiments of this disclosure.

FIG. 8 is a flowchart of an illustrative process for configuring middleware to control a haptic device using a neural network, in accordance with some embodiments of this disclosure.

FIG. 9 is a flowchart of an illustrative process for applying haptic feedback based on non-discrete input, in accordance with some embodiments of this disclosure.

FIG. 10 is a flowchart of an illustrative process for rendering haptics for haptic feedback devices based on sensor input data, in accordance with some embodiments of this disclosure.

FIG. 11 is a flowchart of an illustrative process for rendering haptics for haptic feedback devices based on sensor input data, in accordance with some embodiments of this disclosure.

FIG. 12 is a flowchart of an illustrative process for training and receiving neural networks for specific devices of varying haptic capability, in accordance with some embodiments of this disclosure.

FIG. 13 is a sequence diagram of an illustrative process for processing gesture recognition data and rendering haptic feedback, in accordance with some embodiments of this disclosure.

FIG. 14 is a sequence diagram of an illustrative process for configuring middleware to control a haptic device using control data, in accordance with some embodiments of this disclosure.

### DETAILED DESCRIPTION

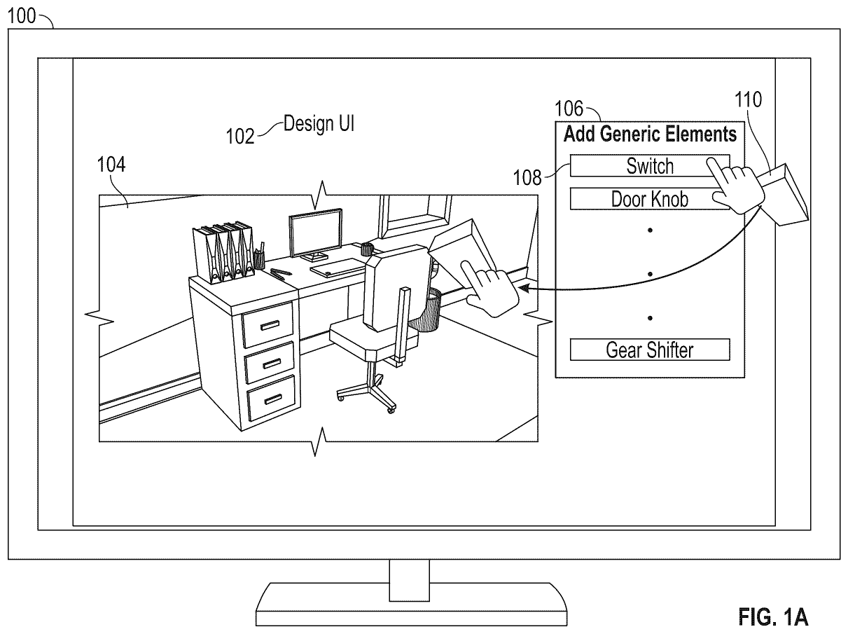

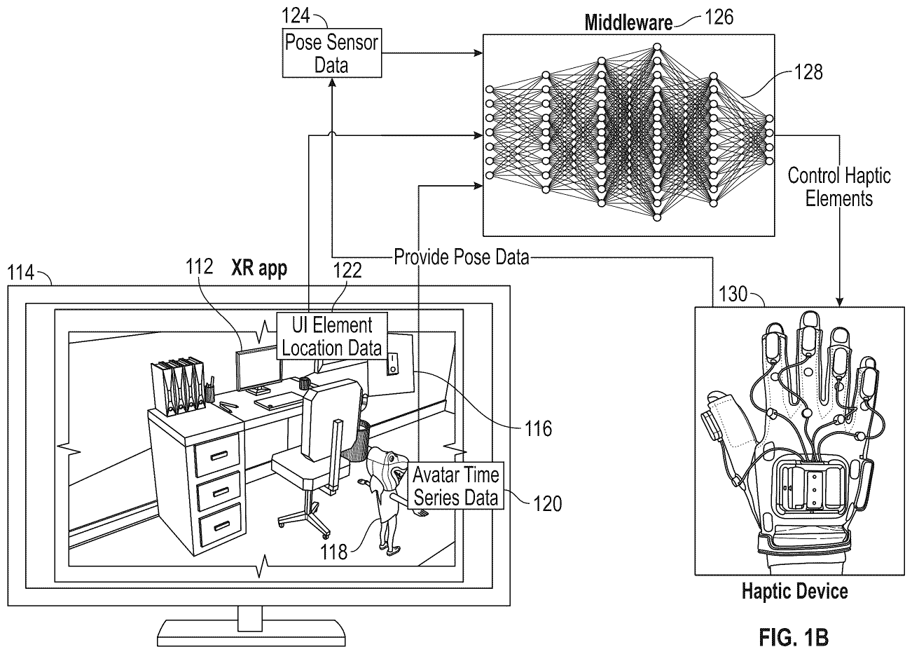

FIGS. 1A-1B show an illustrative example of configuring a middleware to control a haptic device based on input data, in accordance with some embodiments of this disclosure.

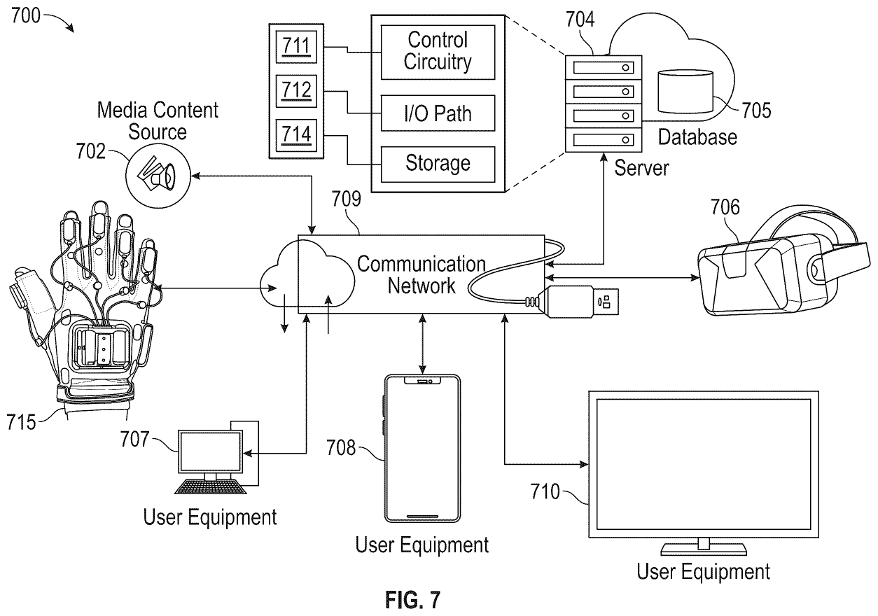

FIGS. 1A-1B illustrate a backend system configured to perform various functionalities described herein. In some embodiments, the backend system comprises or corresponds to an application that may be executed at least in part on a server (e.g., media content source 702 and/or one or more servers 704 of FIG. 7), a user equipment device (e.g., user device 114 of FIG. 1B, devices 706, 707, 708, 710, and/or 715 of FIG. 7, such as, for example, a laptop computer, a personal computer, a desktop computer, a smart television, a smart watch or wearable device, smart glasses, a stereoscopic display, a wearable camera, XR glasses, XR goggles, an XR glove, an XR HMD, a near-eye display device, etc.), or any other suitable user equipment or computing device, or any combination thereof. The middleware may be part of an operating system (OS) of user device 114, may be a third-party application, or may be provided by an XR provider. The application and/or backend system may comprise or employ any suitable number of displays, sensors, or devices such as those described herein, or any other suitable software and/or hardware components, or any combination thereof.

An XR environment 112 (of FIG. 1B) may be designed via a design system running on a first device (e.g., design device 100). Design device 100 may be an example of a first device. The design system may be, for example, Unity, Unreal Engine, Blender, OpenXR, any other suitable design system, or any combination thereof. In some embodiments, the design system provides for display, at design device 100, a design user interface (e.g., design UI 102) for creating XR environment 112. Design UI 102, in some implementations, comprises a pre-render (e.g., pre-render 104) of XR environment 112. Pre-render 104 may later be rendered as XR environment 112 by an XR application. The XR application may process, using a CPU and/or GPU of user device 114, the 3D elements of pre-render 104 and generate for display, at an interface of user device 114, 2D representations of the 3D elements. XR environment 112 (e.g., maps, walls, floors, any other suitable virtual environment elements, or any combination thereof, selected and placed using UI tools of design device 100) may be designed at design UI 102.

Design UI 102, in some implementations, comprises a plurality of generic UI element options (e.g., list 106). For example, list 106 may comprise generic UI elements options such as a switch (e.g., switch option 108), doorknob, gear shifter, etc. Each generic UI element option of list 106 may correspond to a generic UI element (e.g., generic light switch 110) that can be placed into pre-render 104 via a design UI selection. Generally speaking, each generic UI element may be an element representing characteristics (e.g., visual, audible, tactile, functional, etc.) of a certain object, or type or category of object, that may, for example, be found in the real-world. For example, each generic UI element may be a generic shape and size that is typical of the object it is representing and/or may be a selectable UI option. For example, generic light switch 110 (e.g., a rectangular prism) may be placed into pre-render 104 as a placeholder for a virtual light switch, so the design system does not have to generate the detailed visual characteristics of the light switch.

In some embodiments, the design system receives, via design device 100, a design UI selection for placement of generic light switch 110 in a location in XR environment 112, wherein generic light switch 110 represents a functionality of a real-world object (e.g., a real-world light switch). A real-world object may be any suitable tangible, physical object that one might expect to find in the real-world (e.g., as opposed to a virtual world). The real-world object may be, for example, one of a light switch, a steering wheel, or a gear stick. The design UI selection may be made by a click from a mouse or trackpad, a touch on a touchscreen, any other suitable UI selection, or any combination thereof. For example, the design system receives a design UI selection of switch option 108 from a mouse connected to design device 100. Based on the design UI selection of switch option 108, the design system may generate for display generic light switch 110. In some embodiments, the design system retrieves generic light switch 110 from a 3D model database accessible to the design system, any suitable 3D model provider, or any combination thereof. Design device 100 may receive an input or inputs, placed into pre-render 104, of a virtual object(s) and/or a generic UI element(s) (e.g., generic light switch 110) via a design UI interaction. A virtual object may be a 3D XR element that, in some implementations, results in haptic feedback when interacted with by an XR user. Design device 100 may store data of the virtual object(s) and/or generic UI element(s) in a virtual object database and later transmit the data of the virtual object(s) and/or generic UI element(s) to an XR application.

In some embodiments, the backend system configures the XR application to run on a second device (e.g., user device 114), wherein the XR application causes display of XR environment 112. User device 114, e.g., a local device, is an example of the second device. For example, the XR application may be a work application comprising a virtual office environment. In some implementations, the backend system configures a plurality of XR applications to run on a plurality of local devices, wherein each XR application of the plurality of XR applications comprises the at least one generic UI element. For example, the plurality of XR applications may be a plurality of VR video games, each of which comprises a generic light switch element. Each XR application of the plurality of XR applications is configured to run on a plurality of devices (e.g., laptops, smartphones, a plurality of operating systems, etc.). The plurality of applications may be available for download and installation by the plurality of devices via an application database (e.g., an application store). In some embodiments, the XR application generates for display a virtual object (e.g., virtual light switch 116), within XR environment 112, wherein the display is based on at least one generic user interface (UI) element (e.g., generic light switch 110).

As shown in FIG. 1B, in some embodiments, the backend system configures middleware (e.g., middleware 126) to run on user device 114, wherein middleware 126 is configured to control haptic device 130 using at least one neural network (e.g., neural network 128). Middleware 126 may act as an intermediary between the operating system of user device 114 and one or more applications executed by user device 114. For example, middleware 126 may be a software that is part of the operating system of user device 114, may be integrated with the XR application, or may be part of the generic XR 3D engine used for executing different XR experiences provided as isolated content packages. In some embodiments, middleware 126 selects neural network 128 from a plurality of neural networks based on the input data received by middleware 126. Neural network 128 may be one mega neural network. Middleware 126 may download neural network 128 to a random-access memory (RAM) of user device 114. In some implementations, neural network 128 is downloaded to the RAM based on the XR application determining that the virtual object within XR environment 112 may be interacted with via user interaction. In some implementations, middleware 126 erases neural network 128 from the RAM based on the XR application determining that the virtual object within XR environment 112 may no longer be interacted with via user interaction. Memory consumption of user device 114 may be improved by this dynamic neural network loading.

Based on detecting movement of an avatar (e.g., avatar 118) in XR environment 112 by the XR application in a vicinity of virtual light switch 116, in some embodiments, middleware 126 puts input data into neural network 128. An avatar may be a digital or virtual representation of an end-user (e.g., of XR environment 112), and may take various forms depending on the embodiment, the configuration of XR environment 112, or the preferences of an end-user. For example, avatar 118 may represent the function(s), movement(s), and/or appearance of an XR user. Avatar 118 may be any digital expression of an XR user. Avatar 118 may be controlled by, e.g., user interactions with user device 114 or a haptic device. Middleware 126 may detect movement of avatar 118 from at least one sensor of at least one haptic device (e.g., haptic device 130), a keyboard associated with user device 114, a mouse associated with user device 114, contact with an interface of user device 114, any other suitable movement detector, or any combination thereof. In some embodiments, the input data comprises: (i) a time series of user pose data received from at least one sensor (e.g., pose sensor data 124), (ii) a time series of orientation data of avatar 118 received from the XR application (e.g., avatar time series data 120), and (iii) positioning data of avatar 118 with respect to the virtual object received from the XR application (e.g., UI element location data 122). Middleware 126 may perform gesture recognition, e.g., collect pose sensor data 124, through contact or contactless techniques. Contact gesture recognition may comprise finger joint pose detection (for haptic gloves), arm pose detection (for exoskeletons), haptics prop pose detection, any other suitable contact gesture recognition technique, or any combination thereof. Contactless gesture recognition may comprise hand pose tracking, full body pose tracking, eye tracking, RGB-D camera tracking, any other suitable contactless gesture recognition technique, or any combination thereof.

In some embodiments, the types of gestures that middleware 126 can detect are dependent on the type of haptic device that middleware 126 is controlling. For example, middleware 126 may be able to detect finger pose data but not arm pose data when haptic device 130 is a haptic glove. In some implementations, pose sensor data 124 is time series data from which a sliding window sampling is fed into neural network 128 by middleware 126.

In some embodiments, the XR application transmits avatar time series data 120 to middleware 126. Avatar time series data 120 may comprise orientation data of the avatar (e.g., which direction avatar 118 is facing). For example, the XR application may detect that the body of avatar 118 is facing toward virtual light switch 116. In some implementations, the XR application transmits UI element location data 122 (e.g., spatial positioning, relative positioning, and/or virtual distance) to middleware 126. For example, the XR application may detect that avatar 118 is positioned three virtual feet to the left of virtual light switch 116.

In some embodiments, user device 114 has several input devices that can be used for detecting the gesture input and devices may provide data from different types of user gestures. For example, a haptic glove generating the kinesthetic haptic feedback for the user's fingers can also serve as an input device because the device needs to keep track of the finger joint poses, thus generating data (e.g., pose sensor data 124) that can be used for detecting gestures performed with the finger movements. However, even with such haptic gloves, different input devices may be required for tracking the location of the user's hands. In some implementations, input devices can provide data about the whole-body motion of the user, which can also be used for a gesture recognition. In some embodiments, the input device's accuracy varies, and the backend system may adjust an interaction model and UI elements of XR environment 112 accordingly.

In some embodiments, neural network 128 of middleware 126 to outputs control data for controlling haptic device 130 based at least in part on the input data. The control data may be or comprise any data or instructions utilized to control a haptic device, such as haptic device 130. In some embodiments, the input data causes neural network 128 of middleware 126 to output the control data. In some embodiments, an algorithm for determining the control data is determined empirically. In some embodiments, determining the control data includes use of machine learning such as support vector machines (SVMs), multilayer perceptrons (MLPs), convolutional neural networks (CNNs), any other suitable machine learning algorithm, or any combination thereof. For example, based on the input data, neural network 128 may output control data for controlling a haptic glove (e.g., instructions sent to middleware 126 for particular movements and vibrations of the haptic glove). In some embodiments, middleware 126 controls haptic device 130 based on the control data. For example, middleware 126 controls a vibration of a finger of the haptic glove based on the control data output from the at least one neural network.

Haptic device 130 may be a device capable of kinesthetic (e.g., user interaction with haptic device 130) and/or tactile haptic feedback, such as a haptic glove, an exoskeleton, a haptic vest, a haptic actuator, a haptic remote controller, a haptic pen, a haptic prop, any other suitable haptic device, or any combination thereof. For example, haptic device 130 is a haptic glove comprising at least one sensor and at least one actuator. Tactile haptic feedback may comprise spatial feedback, e.g., stimulation to the skin of an XR user, such as surface friction, electrostimulation, skin indenting, any other suitable stimuli, or any combination thereof. Spatial haptic feedback may comprise contactless feedback, such as ultrasonic haptic feedback. Tactile haptic feedback may also comprise non-spatial feedback, such as vibrations.

In some implementations, the backend system pre-trains neural network 128 for generating the control data based on at least one functional description of generic light switch 110. For example, at least one functional description of generic light switch 110 may be a state of generic light switch 110, such as “On,” “Off,” or “Dimmer.” In some embodiments, the backend system receives, from respective middleware of each local device of the plurality of local devices running the plurality of XR applications, user interaction data of a plurality of virtual objects corresponding to the at least one generic UI element. In some embodiments, middleware 126 is a stand-alone implementation containing all the pre-trained neural network models for all the input/output/user preference variations as well as the logic of choosing an appropriate neural network depending on the device-specific capabilities and user-dependent conditions.

For example, the backend system receives user interaction data (e.g., control data, implicit user feedback, explicit user feedback, any other suitable user interaction, or any combination thereof) from a plurality of XR applications, each of which comprises a specific virtual light switch. Each specific virtual light switch corresponds to the generic light switch. In some implementations, each XR application of the plurality of XR applications may comprise the same specific virtual light switch (e.g., virtual light switch 116). The user interaction data may correspond to or be associated with a type(s) of sensor of haptic device 130 associated with user device 114. For example, an advanced haptic glove may provide more detailed user feedback (e.g., detection of smaller finger movements) to the respective XR application, while a rudimentary haptic glove may provide less detailed user feedback (e.g., detection only of larger finger movements) to the respective XR application. The advanced haptic glove may comprise more actuators and sensors, resulting in more detailed user interaction data. In some embodiments, the backend system re-trains the at least one neural network for generating the control data based on the received user interaction data.

In some embodiments, middleware 126 determines at least one of: (a) a type of sensor, or (b) a type of haptic device 130. For example, middleware 126 determines that haptic device 130 (e.g., a haptic glove) comprises two pressure sensors. Haptic device 130 may comprise a plurality of sensor types, such as pressure sensors, temperature sensors, capacitive sensors, resistive sensors, optical cameras, RGB-D cameras, gyroscopes, accelerometers, flex sensors, any other suitable haptic sensor, or any combination thereof. Haptic device 130 may be any of a plurality of haptic device types, such as a haptic glove, an exoskeleton, a haptic vest, a haptic actuator, a haptic remote controller, a haptic pen, a haptic prop, any other suitable haptic device, or any combination thereof. In some implementations, the backend system transmits, to the XR application, data comprising the at least one of: (a) the type of sensor, or (b) the type of haptic device 130. For example, the backend system may transmit to the XR application that haptic device 130 is a haptic glove. In some embodiments, middleware 126 modifies a haptic feedback complexity of virtual light switch 116 based on a number of available sensors, wherein a greater number of available sensors corresponds to a greater haptic feedback complexity and a greater number of available actuators corresponds to a greater haptic feedback complexity.

In some embodiments, the XR application selects the appearance of the virtual object (e.g., virtual light switch 116) based at least in part on the at least one of (a) the type of sensor, or (b) the type of haptic device 130. For example, the XR application selects virtual light switch 116 based on determining that a haptic glove has two pressure sensors in the pointer finger of the glove. In some embodiments, the XR application determines at least one aesthetic element of XR environment 112. An aesthetic element may be a theme of the environment, a color in the environment, a texture in the environment, any other suitable non-functional characteristic, or any combination thereof. For example, the XR application may determine that XR environment 112 is an office with minimalistic interior design. In some implementations, the appearance of the virtual object is selected by the XR application based at least in part on the at least one aesthetic element of XR environment 112. For example, the XR application selects a minimalistic, sleek virtual light switch to correspond with the minimalistic interior design of XR environment 112.

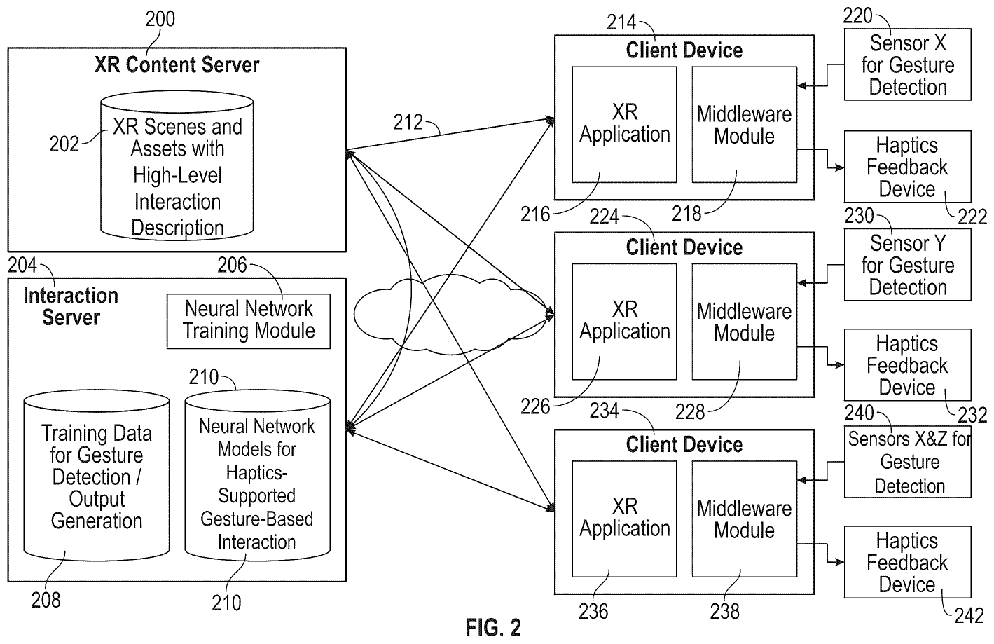

FIG. 2 depicts an illustrative example of transmitting control data to a plurality of local devices and controlling a plurality of haptic devices, via a plurality of middleware modules, according to the control data, in accordance with some embodiments of this disclosure. An interaction server (e.g., interaction server 204) may store training data (e.g., training data 208) associated with each haptic feedback and gesture input modality collected and created for specific device models falling into the category. In some embodiments, interaction server 204 is the backend system as described in connection with FIGS. 1A-1B. In some embodiments, training data 208 comprises the recorded input data from the gesture input device (e.g., client devices 214, 224, and 234 and/or user device 114 as described in connection with FIGS. 1A-1B), changes in the UI element states, and output signals rendered for the haptic feedback device (e.g., haptics feedback devices 222, 232, and 242 and/or haptic device 130 as described in connection with FIGS. 1A-1B). Output signal to the haptic feedback device may comprise the device signal producing the haptic feedback that is associated with the gesture and the related UI element state changes (e.g., a virtual light switch turning on and off).

In some embodiments, interaction server 204 collects supported interaction metaphors (e.g., generic UI elements as described in connection with FIGS. 1A-1B). Supported interaction metaphors may be formed as a collection of template UI elements and neural networks for gesture detection and haptics rendering (e.g., neural network models 210). Each supported interaction metaphor may define the various gesture detection and haptics output device combinations that are supported together with the associated template UI elements. New interaction metaphors may be added by defining template UI elements and providing training data 208, which consists of training samples for performing the gesture recognition for gesture recognition devices to be supported and desired haptics output for haptic feedback devices desired to be supported. In addition to the initial input, training data 208 may be added cumulatively during the run-time operation of interaction server 204, thus continuously extending the supported interaction metaphors and haptics-supported gesture detection and haptic feedback device support.

In some embodiments, training of the end-to-end models requires a large amount of training data. The initial training data may be collected by harvesting the data from existing methods that feature haptics-supported, gesture-based interaction without the adaptation. Training data serving as initial training data may be collected by capturing the input signals from the gesture detection device and capturing associated output signals created for the haptic feedback device. The interaction metaphor and UI state may be captured by inspecting the XR experience state by observing the graphics output of the XR experience. In some implementations, harvesting data on multiple XR experiences created for single device setup builds a training data set that features gesture input and haptics output of a large variety of device combinations for a single interaction metaphor.

In some implementations, training data 208 is cumulated during run-time as novel devices become available or as the new training data gets collected, e.g., as the end users create training data for the gesture recognition or more data for the haptic feedback generation is created with further modeling or simulation. Interaction server 204 may use the collected training data 208 for training the end-to-end neural network models 210 for the different input/output device combinations using neural network training module 206. As new data becomes available, interaction server 204 may re-train the neural network models 210 to improve the performance. In some embodiments, neural network models 210 are trained using transfer learning approach in cases where the input/output mapping is somewhat similar to improve the performance across the different neural networks. Federated learning can be used to improve the model, and over-the-air updates can be pushed to devices. In some embodiments, interaction server 204 relies on small/lightweight neural network models. This permits the neural network models to be loaded into program memory as needed (e.g., when a user is close to switch) keeping memory footprint on an embedded device manageable. It also reduces compute (power consumption) as well as inference latency.

It is possible for the user to retrain the neural network performing the haptics-supported, gesture-based interaction with their own gesture input to either improve the performance in case user specific characteristics make the gesture recognition not perform optimally or if the user wants to customize the gesture. However, such customization may require local retraining on the client side and the resulting user-specific adaptation results just in local personalization of the specific neural network addressing specific local device capabilities. However, such local retraining data is sent to interaction server 204 and is included in the next retraining iteration, so local customization done on the client side will create cumulative training data for the interaction server. In some embodiments, interaction server 204 distributes the data for content authors (e.g., designers using design systems running on design devices as described in connection with FIG. 1A) to design XR experiences (e.g., XR scenes and assets 202) employing haptics-supported, gesture-based interactions. Interaction server 204 may send data about available interaction metaphors and different UI elements associated with supported interaction metaphors.

During run-time, interaction server 204 waits for the requests from the middleware modules (e.g., middleware modules 218, 228, 238) running on client devices 214, 224, 234, respectively. Middleware modules 218, 228, and 238 receive, from respective associated sensor(s) (e.g., sensor X 220, sensor Y 230, and sensors X and Z 240, respectively), data that the middleware inputs into a neural network(s) as training data. The data received from the sensors may include data describing client device capabilities and/or haptics supported by respective haptic feedback devices (e.g., 222, 232, 242). Based on the data describing the client device capabilities, interaction server 204 sends the correct neural network to the respective client device to be used by the respective middleware module for the haptics-supported, gesture-based interaction. Client devices 214, 224, 234 may comprise at least one XR application, e.g., XR applications 216, 226, 236, respectively. XR experiences are created as an offline process by the content author. XR content may be authored using any suitable real-time scene editor (e.g., design system). In a real-time 3D scene editor (such as Unity or Unreal), a content author builds the XR experience by combining imported 3D assets, audio files, material definitions, etc. The content author also defines the rules of interaction of elements and user input controls that form the logic of the interactive and immersive XR experience.

In some embodiments, for haptics-supported, gesture-based interactions, the real-time 3D scene editor communicates with interaction server 204 to receive an up-to-date collection of supported interaction metaphors. When the real-time 3D scene editor has the up-to-date data on the supported interactions, the content author may create UI elements (e.g., virtual light switch 116 as described in connection with FIG. 1B) associated with the interaction metaphors to the XR scene being composited. The content author may modify the visual appearance of the UI elements and other associated behaviors such as sound effects within the limits of not altering the behavior in terms of input gestures and haptics rendering. The content author may also define the logic associated with the interaction metaphor, e.g. virtual lights are turned on/off depending on the interaction metaphor state.

For example, available haptics-supported, gesture-based interaction metaphors can be provided to the content author through real-time 3D scene editor asset packages comprising a collection of the UI elements that can be used depending on the client device input/output capabilities. The content author may test how the different UI element versions fit the XR scene and adapt their visual appearance to suit the desired XR experience in terms of the look and feel. Different UI assets are delivered to the end client along with the normal XR content delivery package, while the associated interaction metaphor definitions are delivered using a high-level description. As the content author has defined interaction logic for the XR experience that employs haptics-supported, gesture-based interaction, the content authoring tool can request neural networks that enable high-level interaction translation to a device-specific gesture detection and haptics rendering in order to enable testing of the XR experience with the interaction features.

Once the content author has the XR experience design completed, the real-time 3D scene editor exports the XR experience into a run-time format so that end client devices 214, 224, 234 can download the full executable experience together with the content, or in case of using a generic XR application, exporting the XR content into a content package, at 212, which can be downloaded and executed by the generic XR application. If the XR experience contains haptics-supported, gesture-based interaction, the high-level description of the gestures and interaction metaphors is included with the content to be downloaded by the client device. Run-time XR experience application and/or content package exported by the real-time 3D scene editor is uploaded to a content server (e.g., XR content server 200), which distributes the XR content to client devices 214, 224, 234 based on the client device requests.

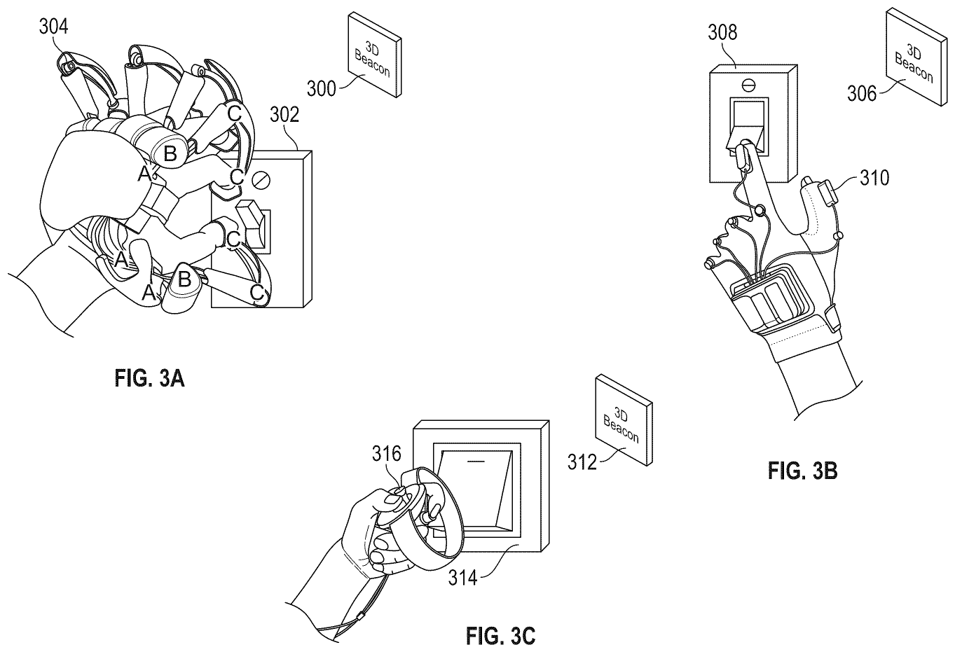

FIGS. 3A-3C depict illustrative examples of selecting a virtual object based on a type of haptic device, in accordance with some embodiments of this disclosure. In some embodiments, a local device (e.g., user device 114 as described in connection with FIGS. 1A-1B) runs a system (e.g., the backend system as described in connection with FIGS. 1A-1B). User device 114 may comprise a middleware module (e.g., middleware 126 as described in connection with FIGS. 1A-1B) and an XR application. In FIG. 3A, middleware 126 receives input data (e.g., as described in connection with FIGS. 1A-1B) from a full hand kinesthetic force feedback glove (e.g., haptic device 304). In some embodiments, haptic device 304 provides joint poses for all fingers used for gesture recognition in addition to the full glove pose tracking provided by the outside-looking-in 3D tracking with the 3D tracking beacons (e.g., 3D beacon 300). In some embodiments, the backend system adapts a generic light switch UI element (e.g., generic light switch 110 as described in connection with FIGS. 1A-1B) to a virtual light switch (e.g., virtual light switch 302) with clearly defined shape that can be grabbed with the fingertips. Haptic device 304, via instructions from middleware 126, may provide defined force feedback in terms of finger kinesthetic force feedback. Kinesthetic force feedback may comprise contact forces when fingers are pinching the switch, resisting force when the user is flipping the switch, and/or impact force when virtual light switch 302 flips to a different state (e.g., on or off).

In FIG. 3B, a tactile feedback glove (e.g., haptic device 310) may not have full hand tracking available. In some embodiments, outside-looking-in tracking with 3D beacons (e.g., 3D beacon 306) provides tracking information to middleware 126 about the whole hand pose in the space, and haptic device 310 provides information about whole finger bending angles. The input data from the whole hand pose and the finger bending angles may be used to detect when the user is performing a pointing gesture with the index finger at the proximity of virtual light switch 308. When middleware 126 detects the gesture, in some implementations, tactile force feedback is driven to the index fingertip of haptic device 310. Middleware 126 may provide instructions for modulating the force feedback frequency to indicate when the movement of the pointing index finger will trigger the flip of the light switch state. When the state of virtual light switch 308 has been changed based on the user gesture, the state change is indicated to the user with a distinctive vibration impact to the fingertip of haptic device 310.

In FIG. 3C, in some embodiments, an XR controller (e.g., haptic device 316) is tracked by an outside-looking-in 3D tracking with 3D beacons (e.g., 3D beacon 312). The 3D poses of haptic device 316 and input from the several controller buttons included with haptic device 316 may be used by middleware 126 for gesture detection. The vibration created with the controller-integrated vibration motor is used for creating tactile haptic feedback. In some embodiments, the backend system adapts the generic light switch UI element (e.g., generic light switch 110 as described in connection with FIGS. 1A-1B) to a virtual light switch (e.g., virtual light switch 314) which has a large contact area in order to accommodate to the lower accuracy of haptic device 316 tracking data and vague interaction area. Middleware 126 may instruct haptic device 316 to create tactile force feedback when haptic device 316 is moving to the proximity of virtual light switch 314. In some embodiments, the tactile force feedback is modulated to indicate the distance from haptic device 316 to virtual light switch 314. In some implementations, haptic device 316, via pressing a control button on haptic device 316, triggers the flip of the light switch state. The state change of light switch 314 may be indicated to the user with a distinctive vibration impact of haptic device 316.

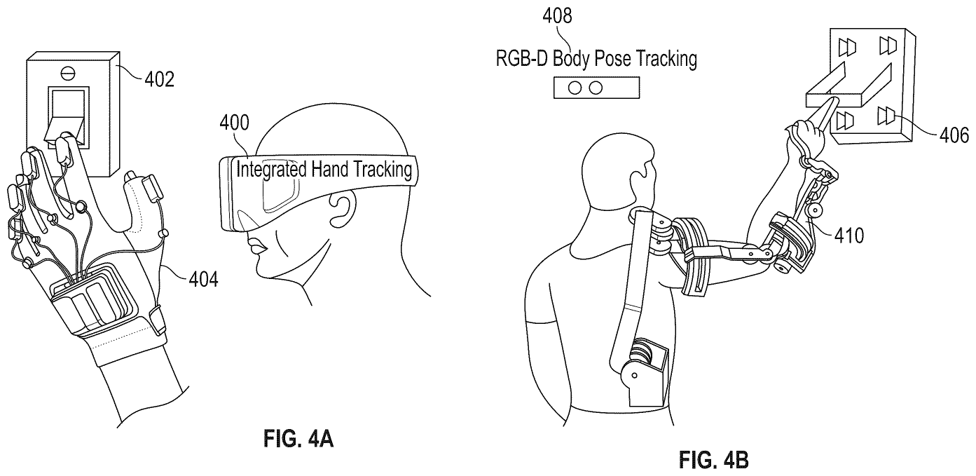

FIGS. 4A-4B depict illustrative examples of selecting a virtual object based on a type of haptic device, in accordance with some embodiments of this disclosure. In some embodiments, an XR head-mounted display (HMD) (e.g., HMD 400) runs a system (e.g., the backend system as described in connection with FIGS. 1A-1B). HMD 400 may comprise a middleware module (e.g., middleware 126 as described in connection with FIGS. 1A-1B) and an XR application. In FIG. 4A, middleware 126 receives input data (e.g., as described in connection with FIGS. 1A-1B) from a haptic feedback glove (e.g., haptic device 404) providing vibration feedback for each fingertip. In some embodiments, HMD 400 uses integrated hand tracking for the gesture detection. HMD 400 may perform integrated hand tracking by e.g., RGB-D cameras, IR cameras, any other suitable sensor, or any combination thereof. Hand tracking provides information about the hand and fingertip locations of haptic device 404 within the virtual environment (e.g., XR environment 112 as described in connection with FIGS. 1A-1B).

In some embodiments, the backend system adapts the generic light switch UI element (e.g., generic light switch 110 as described in connection with FIGS. 1A-1B) to a virtual light switch (e.g., virtual light switch 402) that has a clearly defined surface texture and large shape, enabling synchronization of the finger contact with the geometry of virtual light switch 402 and tactile feedback generation. Tactile feedback generation has variation at the proximity of the contact surface of virtual light switch 402 to indicate when the flip of the state is to take place. When the fingertip of haptic device 404 is moved through the contact surface of virtual light switch 402, the state flip is triggered and the switch of the state is indicated to haptic device 404 with a distinctive vibration impact to the fingertip.

In some embodiments, a local device (e.g., user device 114 as described in connection with FIGS. 1A-1B) runs a system (e.g., the backend system as described in connection with FIGS. 1A-1B). User device 114 may comprise a middleware module (e.g., middleware 126 as described in connection with FIGS. 1A-1B) and an XR application. In FIG. 4B, middleware 126 receives input data (e.g., as described in connection with FIGS. 1A-1B) from a haptics exoskeleton (e.g., exoskeleton 410). User device 114 may use exoskeleton 410 to provide full arm kinesthetic haptic feedback. In some embodiments, an external RGB-D sensor (e.g., RGB-D body pose tracker 408) is used for performing full body pose tracking of the user wearing exoskeleton 410. RGB-D body pose tracker 408 may provide an overall skeletal pose of the user and few hand poses such as hand grasping and/or hand open or closed.

In some embodiments, the backend system adapts the generic light switch UI element (e.g., generic light switch 110 as described in connection with FIGS. 1A-1B) to a virtual light switch (e.g., virtual light switch 406) that features a large handle that can be fully grabbed and requires large, full arm motion to switch state. Sensor data from RGB-D body pose tracker 408 is used for determining when exoskeleton 410 performs a grabbing gesture in the proximity of virtual light switch 406. When RGB-D body pose tracker 408 detects the gesture, middleware 126 instructs exoskeleton 410 to render full arm kinesthetic force feedback to produce resisting force when the user grabbing virtual light switch 406 is trying to flip it to a different state. Exoskeleton 410 may render impact force when virtual light switch 406 flips to a different state.

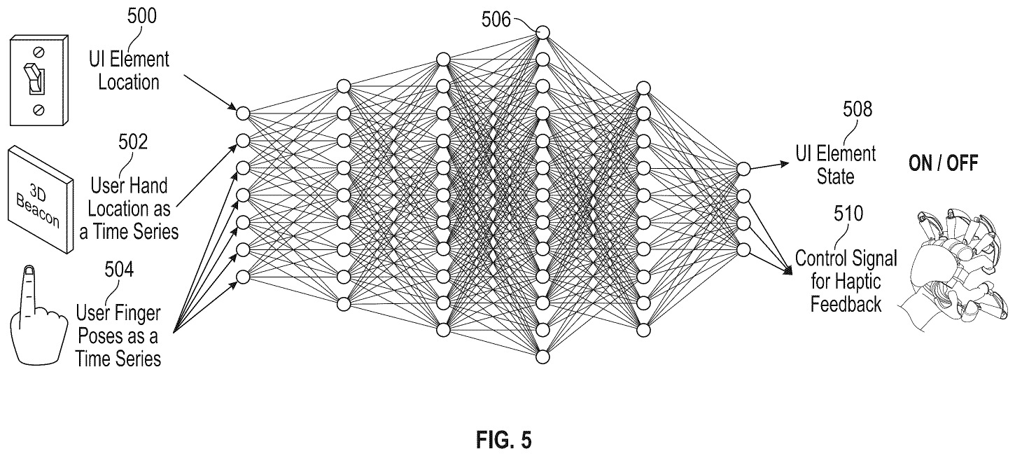

FIG. 5 depicts an illustrative example of a multi-layer neural network for inferring UI element state and haptic feedback device control signal, in accordance with some embodiments of this disclosure. In some embodiments, a local device (e.g., user device 114 as described in connection with FIGS. 1A-1B) runs a system (e.g., the backend system as described in connection with FIGS. 1A-1B). User device 114 may comprise a middleware module (e.g., middleware 126 as described in connection with FIGS. 1A-1B) and an XR application. The XR application may cause display of an XR environment (e.g., XR environment 112 as described in connection with FIGS. 1A-1B). In some implementations, middleware 126 is configured to control a haptic device (e.g., haptic device 130 as described in connection with FIGS. 1A-1B) using at least one multi-layer neural network (e.g., neural network 506).

Neural network 506 may receive input data comprising the location of a generic UI element or virtual object (e.g., UI element location 500), hand location captured by a 3D tracking beacon observing a tracking target embedded within haptic device 130 (e.g., user hand location 502), and the finger poses detected by haptic device 130 generating kinesthetic forced feedback for the user's fingers (e.g., user finger poses 504). In some embodiments, neural network 506 includes an input layer (left side), multiple (e.g., four) hidden layers (middle), and an output layer (right side). Neural network 506 may be one of a convolutional neural network (CNN), recurrent neural network (RNN), feed-forward neural network, modular neural network, any other suitable neural network, or any combination thereof. In some embodiments, neural network 506 adjusts the weights of the neuron connections in a training process where neural network 506 learns the weights resulting in the smallest error of mapping input data to the output data (e.g., UI element state 508 and control signal for haptic feedback 510) featured in the training data.

In some embodiments, the backend system selects more than one neural network from a plurality of neural networks. In some embodiments, the backend system selects neural network 506 from a plurality of neural networks. The backend system may select and train neural network 506 based on data engineering and/or modeling techniques. Neural network training techniques may comprise supervised learning, unsupervised learning, reinforcement learning, gradient descent, brute force, Newton's method, any other suitable neural network training technique, or any combination thereof. Data engineering techniques may comprise exploration, cleaning, normalizing, feature engineering, and scaling. Modeling techniques may comprise model selection, training, evaluation, and tuning. The predictive model may be operationalized using registration, deployment, monitoring, and/or retraining techniques. In some embodiments, neural network 506 is a large neural network (e.g., high complexity, computational resources, number of layers, etc.). The backend system may train neural network 506 for a plurality of types of devices (e.g., to accommodate different combinations of gestures and haptic feedback rendering). The differences among device types and capabilities can be intrinsically transformed to the embeddings of the network. Such aspects allow the backend system to avoid adding new neural networks every time a new device is added to the ecosystem.

Neural network 506 may be designed such that an extensible input layer is used to accommodate a range of parameter combinations including device type, assistive sensory measurement, gestures, etc. Each of the parameters can be thought of as one conditioning. For a more complex device, additional conditioning will be available, while for a simpler device, it can be either default or excused conditioning. The use of a large model may also help to eliminate the needs of categorizing training data for different devices, which may then improve the efficiency in collecting and establishing the training data.

In some embodiments, the training of neural network 506 may leverage the action-feedback modeling in designing a haptic model for a target device (e.g., haptic device 130). The data-driven modeling, measurement-based modeling, or hybrid modeling typically collect physical object interaction data or simulate action-response mapping that is governed by a parametrical model. This is useful when a new device becomes available and neural network 506 learns the expected feedback mapping for users to start using the device. Neural network 506 may evolve as more training data gets collected. Neural network 506 can be trained in a simulated environment especially during the development. The simulation to real transfer learning can bridge the gap between the simulated training data and real-world haptic rendering. This is also part of the continuous learning to evolve and optimize neural network 506 for better user experiences.

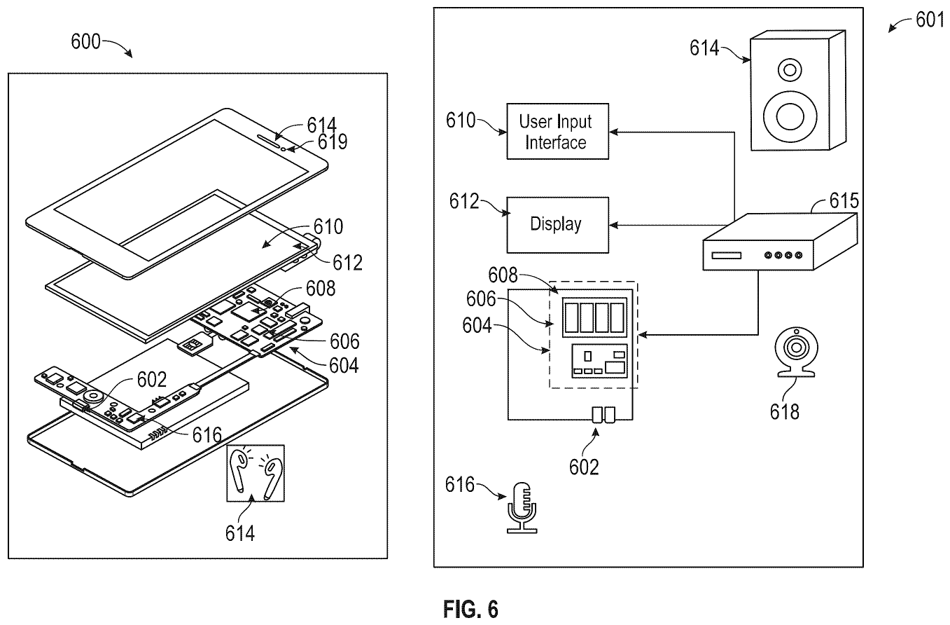

FIGS. 6-7 describe illustrative devices, systems, servers, and related hardware for modifying a virtual reality environment to help prevent a collision with a real-world object, in accordance with some embodiments of the present disclosure. FIG. 6 shows generalized embodiments of illustrative user equipment 600 and 601, which may correspond to, e.g., user device 114 of FIGS. 1A-1B. For example, user equipment 600 may be a smartphone device, a tablet, a near-eye display device, an XR device, or any other suitable device capable of participating in a XR environment, e.g., locally or over a communication network. In another example, user equipment 601 may be a user television equipment system or device. User equipment 601 may include set-top box 615. Set-top box 615 may be communicatively connected to microphone 616, audio output equipment 614 (e.g., speaker or headphones), and display 612. In some embodiments, microphone 616 may receive audio corresponding to a voice of a user and/or ambient audio data. In some embodiments, display 612 may be a television display or a computer display. In some embodiments, set-top box 615 may be communicatively connected to user input interface 610. In some embodiments, user input interface 610 may be a remote-control device. Set-top box 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 7. In some embodiments, user equipment 600 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 600. In some embodiments, user equipment 600 comprises a rechargeable battery that is configured to provide power to the components of the device.

Each one of user equipment 600 and user equipment 601 may receive content and data via input/output (I/O) path 602. I/O path 602 may provide content (e.g., broadcast programming, on-demand programming, internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 to one or more communications paths (described below). I/O functions may be provided by one or more of these communications paths but are shown as a single path in FIG. 6 to avoid overcomplicating the drawing. While set-top box 615 is shown in FIG. 6 for illustration, any suitable computing device having processing circuitry, control circuitry, and storage may be used in accordance with the present disclosure. For example, set-top box 615 may be replaced by, or complemented by, a personal computer (e.g., a notebook, a laptop, a desktop), a smartphone (e.g., user equipment 600), an XR device, a tablet, a network-based server hosting a user-accessible client device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 604 executes instructions for the system (as described in connection with FIGS. 1-3) stored in memory (e.g., storage 608). Specifically, control circuitry 604 may be instructed by the system to perform the functions discussed above and below. In some implementations, processing or actions performed by control circuitry 604 may be based on instructions received from the system.

In client/server-based embodiments, control circuitry 604 may include communications circuitry suitable for communicating with a server or other networks or servers. The system may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 608, and executed by control circuitry 604 of a user equipment 600.

In some embodiments, the application may be a client/server application where only the client application resides on user equipment 600, and a server application resides on an external server (e.g., server 704 and/or media content source 702). For example, the application may be implemented partially as a client application on control circuitry 604 of user equipment 600 and partially on server 704 as a server application running on control circuitry 711. Server 704 may be a part of a local area network with one or more of user equipment 600, 601 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 704 and/or an edge computing device), referred to as “the cloud.” User equipment 600 may be a cloud client that relies on the cloud computing capabilities from server 704 to generate personalized engagement options in a VR environment.

Control circuitry 604 may include communications circuitry suitable for communicating with a server, edge computing systems and devices, a table or database server, or other networks or servers. The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 7). In addition, communications circuitry may include circuitry that enables peer-to-peer communication of user equipment, or communication of user equipment in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 608 may be used to store various types of content described herein as well as application data described above. Nonvolatile memory may also be used (e.g., to launch a boot-up routine and other instructions). Cloud-based storage, described in relation to FIG. 6, may be used to supplement storage 608 or instead of storage 608. Non-transitory memory may store instructions that, when executed by control circuitry, I/O circuitry, any other suitable circuitry or combination thereof, executes functions of an application as described above.

Control circuitry 604 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 604 may also include scaler circuitry for upconverting and downconverting content into the preferred output format of user equipment 600. Control circuitry 604 may also include digital-to-analog converter circuitry and analog-to-digital converter circuitry for converting between digital and analog signals. The tuning and encoding circuitry may be used by user equipment 600, 601 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment 600 and user equipment 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612. Display 612 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of user equipment 600 and user equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The application may be implemented using any suitable architecture. For example, it may be a stand-alone application wholly implemented on each one of user equipment 600 and user equipment 601. In such an approach, instructions of the application may be stored locally (e.g., in storage 608), and data for use by the application is downloaded on a periodic basis (e.g., from an out-of-band feed, from an internet resource, or using another suitable approach). Control circuitry 604 may retrieve instructions of the application from storage 608 and process the instructions to provide video conferencing functionality and generate any of the displays discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 604 may allow a user to provide user profile information or may automatically compile user profile information. For example, control circuitry 604 may access and monitor network data, video data, audio data, processing data, content consumption data, and/or any other suitable data being accessed by a first user. Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the application is a client/server-based application. Data for use by a thick or thin client implemented on each one of user equipment 600 and user equipment 601 may be retrieved on demand by issuing requests to a server remote to each one of user equipment 600 and user equipment 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on user equipment 600. This way, the processing of the instructions is performed remotely by the server while the resulting displays (e.g., that may include text, a keyboard, or other visuals) are provided locally on user equipment 600. User equipment 600 may receive inputs from the user via user input interface 610 and transmit those inputs to the remote server for processing and generating the corresponding displays. For example, user equipment 600 may transmit a communication to the remote server indicating that an up/down button was selected via user input interface 610. The remote server may process instructions in accordance with that input and generate a display of the application corresponding to the input (e.g., a display that moves a cursor up/down). The generated display is then transmitted to user equipment 600 for presentation to the user.

In some embodiments, the application may be downloaded and interpreted or otherwise run by an interpreter or virtual machine (run by control circuitry 604). In some embodiments, the application may be encoded in the ETV Binary Interchange Format (EBIF), received by control circuitry 604 as part of a suitable feed, and interpreted by a user agent running on control circuitry 604. For example, the application may be an EBIF application. In some embodiments, the application may be defined by a series of JAVA-based files that are received and run by a local virtual machine or other suitable middleware executed by control circuitry 604. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 7, user equipment 706, 707, 708, 710, 715 (which may correspond to user equipment, e.g., design device 100 of FIG. 1A and/or user device 114 of FIG. 1B) may be coupled to communication network 709. Communication network 709 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 709) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 709.

System 700 may comprise media content source 702, one or more servers 704, and/or one or more edge computing devices. In some embodiments, the application may be executed at one or more of control circuitry 711 of server 704 (and/or control circuitry of user equipment 706, 707, 708, 710, 715 and/or control circuitry of one or more edge computing devices). In some embodiments, the media content source and/or server 704 may be configured to host or otherwise facilitate video communication sessions between user equipment 706, 707, 708, 710, 715 and/or any other suitable user equipment, and/or host or otherwise be in communication (e.g., over communication network 709) with one or more social network services.

In some embodiments, server 704 may include control circuitry 711 and storage 714 (e.g., RAM, ROM, Hard Disk, Removable Disk, etc.). In some embodiments, storage 714 may store, in non-transitory computer readable memory, the code for all XR applications, middleware, and system described in connection with some embodiments of this disclosure. Storage 714 may store one or more databases. Server 704 may also include an I/O path 712. In some embodiments, I/O path 712 is an I/O circuitry. I/O circuitry may be a NIC card, audio output device, mouse, keyboard card, any other suitable I/O circuitry device or combination thereof. I/O path 712 may provide video conferencing data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 to one or more communications paths.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 711 executes instructions for an emulation system application stored in memory (e.g., the storage 714). Memory may be an electronic storage device provided as storage 714 that is part of control circuitry 711. Memory may store instruction to run the application.

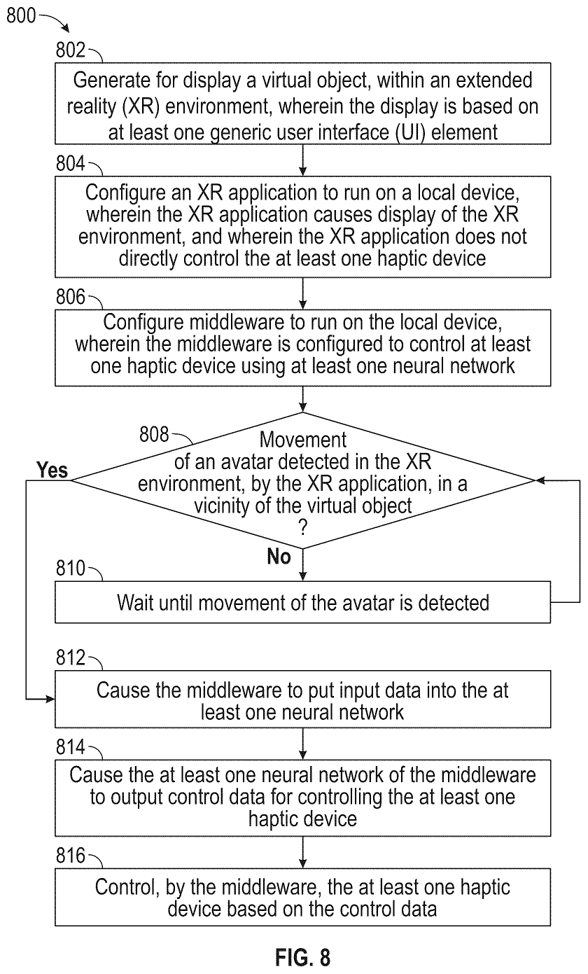

FIG. 8 is a flowchart of an illustrative process for configuring middleware to control a haptic device using a neural network, in accordance with some embodiments of this disclosure. In various embodiments, the individual steps of process 800 may be implemented by one or more components of the devices and systems of FIGS. 1-7 and may be performed in combination with any of the other processes and aspects described herein. Although the present disclosure may describe certain steps of process 800 (and of other processes described herein) as being implemented by certain components of the devices and systems of FIGS. 1-7, this is for purposes of illustration only. It should be understood that other suitable components of the devices and systems may implement those steps instead.

In some embodiments, at 802, control circuitry (e.g., control circuitry 604 of user equipment 600 and/or control circuitry 711 of server 704) generates for display a virtual object, within an XR environment, wherein the display is based on at least one generic UI element. For example, control circuitry generates for display a virtual light switch (e.g., virtual light switch 116 as described in connection with FIG. 1B) at a laptop (e.g., user device 114 as described in connection with FIG. 1B) displaying a virtual office setting (e.g., XR environment 112 as described in connection with FIG. 1B). Virtual light switch 116 may be based on a placeholder UI element (e.g., generic light switch 110 as described in connection with FIG. 1A). In some implementations, at 804, control circuitry of a backend system configures an XR application to run on a local device, wherein the XR application causes display of the XR environment, and wherein the XR application does not directly control at least one haptic device. For example, control circuitry configures a video game (e.g., an XR application) to run on user device 114. User device 114 may receive data from sensors of a haptic device such as a haptic glove (e.g., haptic device 130 as described in connection with FIG. 1B).

In some embodiments, at 806, control circuitry configures middleware (e.g., middleware 126 as described in connection with FIGS. 1A-1B) to run on the local device (e.g., user device 114), wherein middleware 126 is configured to control the at least one haptic device using at least one neural network. For example, user device 114 comprises middleware 126 and an XR application. In some implementations, at 808, control circuitry of the XR application determines whether movement of an avatar in the XR environment in a vicinity of the virtual object is detected. Control circuitry of the XR application may detect avatar movement based on movement data, from the at least one sensor, of at least one component of haptic device 130. For example, a pressure sensor of haptic device 130 detects pressure from the pointer finger of the haptic glove and transmits this data to the XR application. Control circuitry of the XR application may also detect avatar movement based on receiving a user interface interaction, via a control of the local devicer. For example, the XR application may receive, via a press of a key of a keyboard of user device 114, instructions to move the avatar by a certain amount in a certain direction (e.g., two units left, one unit down, etc.).

In some embodiments, at 810, based on control circuitry of the XR application detecting that the avatar is not moving in the XR environment in a vicinity of the virtual object, control circuitry waits until movement of the avatar is detected. In some implementations, at 812, based on control circuitry of the XR application detecting movement of the avatar in the XR environment in a vicinity of the virtual object, middleware puts input data into the at least one neural network. For example, control circuitry of the XR application detects movement of the avatar via the movement of the at least one sensor and then causes middleware 126 to put input data (e.g., pose sensor data 124, avatar time series data 120, and UI element location data 122 as described in connection with FIG. 1B) into neural network 128. In some embodiments, at 814, control circuitry of the XR application causes the at least one neural network of the middleware to output control data for controlling the at least one haptic device. At 816, control circuitry controls, by the middleware, the at least one haptic device based on the control data. Middleware 126 may control haptic device 130 based on the control data (for example, instructions for a type of haptic feedback, such as vibration) output from neural network 128.

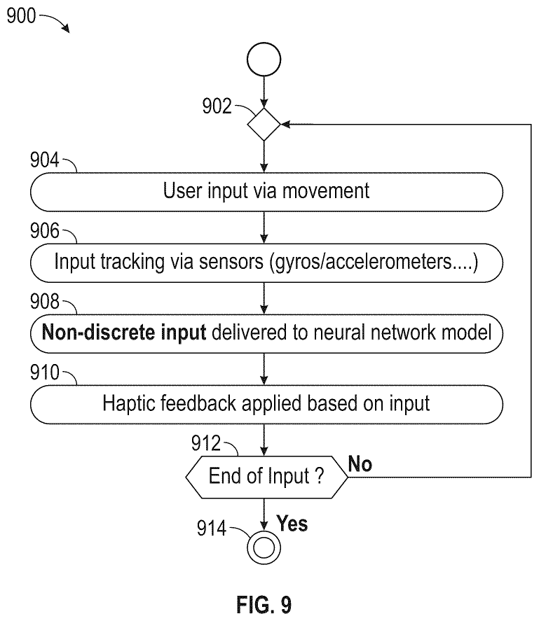

FIG. 9 is a flowchart of an illustrative process for applying haptic feedback based on non-discrete input, in accordance with some embodiments of this disclosure. In various embodiments, the individual steps of process 900 may be implemented by one or more components of the devices and systems of FIGS. 1-7 and may be performed in combination with any of the other processes and aspects described herein. Although the present disclosure may describe certain steps of process 900 (and of other processes described herein) as being implemented by certain components of the devices and systems of FIGS. 1-7, this is for purposes of illustration only. It should be understood that other suitable components of the devices and systems may implement those steps instead.

In some embodiments, at 902, process 900 begins. At 904, in some implementations, control circuitry (e.g., control circuitry 604 of user equipment 600 and/or control circuitry 711 of server 704) receives user input via movement. For example, a user wearing a haptic glove (e.g., haptic device 130 as described in connection with FIG. 1B) moves the pointer finger of the haptic glove. Haptic device 130 transmits data of the movement to the control circuitry of the local device (e.g., user equipment 600). In some embodiments, at 906, control circuitry tracks input (e.g., gestures) via sensors (e.g., gyroscopes/accelerometers). Control circuitry of an XR application may detect movement, via the haptic device, using techniques described in connection with FIG. 8. For example, control circuitry detects the movement of the finger of haptic device 130 via a pressure sensor of the haptic glove. Control circuitry may detect a location of the movement of the finger of haptic device 130 relative to a UI element (e.g., generic light switch 110 or virtual light switch 116 as described in connection with FIGS. 1A-1B). In some embodiments, control circuitry continuously captures the gestures.

In some embodiments, at 908, control circuitry delivers non-discrete input to a neural network (NN) model (e.g., an AI model). Control circuitry may tunnel the actual user input parameters (relative to the UI element) to a haptic device driver of haptic device 130. The haptic device driver may then translate the user input to a haptic output (e.g., haptic feedback). Gesture recognition may be achieved by integrating the neural network models to train and inference for haptic feedback rendering. In some embodiments, control circuitry may translate the high-level description of gestures and 3D user interaction metaphors (e.g., generic UI elements) into a data processing device depending on the client device and haptic device capabilities. Instead of defining discrete gestures and triggering discrete feedback, the neural network allows non-discrete, continuous, and possibly complex haptic support for the whole interaction sequence.

The neural network may determine haptic feedback that is adapted to the target device (e.g., haptic glove). In some implementations, at 910, control circuitry applies the haptic feedback based on the non-discrete input. For example, via the middleware of the local device, control circuitry instructs haptic device 130 to generate the haptic feedback (e.g., a vibration of an actuator of haptic device 130). At 912, control circuitry determines whether input has ended. If input has ended, control circuitry may proceed to complete at 914. If input has not ended, control circuitry may revert to 902.

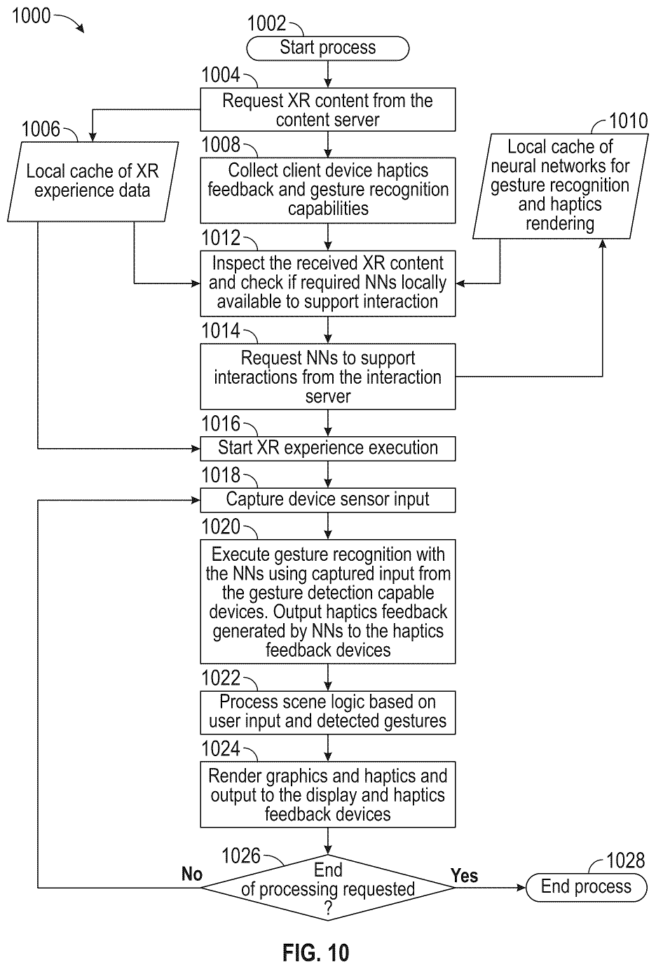

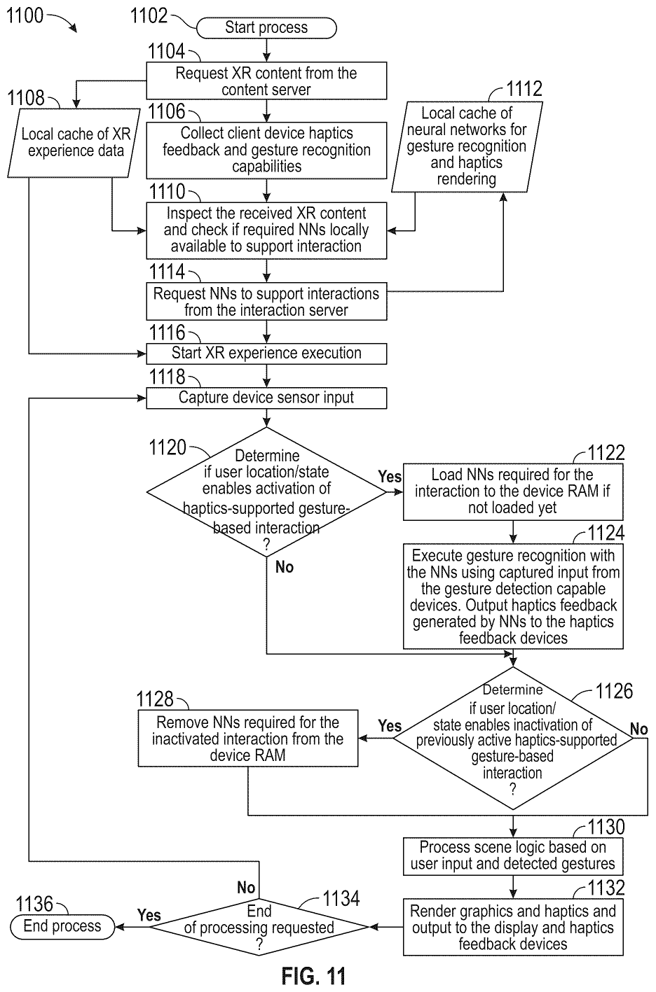

FIG. 10 is a flowchart of an illustrative process for rendering haptics for haptic feedback devices based on sensor input data, in accordance with some embodiments of this disclosure. In various embodiments, the individual steps of process 1000 may be implemented by one or more components of the devices and systems of FIGS. 1-7 and may be performed in combination with any of the other processes and aspects described herein. Although the present disclosure may describe certain steps of process 1000 (and of other processes described herein) as being implemented by certain components of the devices and systems of FIGS. 1-7, this is for purposes of illustration only. It should be understood that other suitable components of the devices and systems may implement those steps instead.

In some embodiments, at 1002, process 1000 starts. In some implementations, at 1004, control circuitry (e.g., control circuitry 604 of user equipment 600 and/or control circuitry 711 of server 704) requests XR content from the content server. Control circuitry of an XR application may transmit the request for the XR content to local cache of XR experience data 1006. In some implementations, at 1008, control circuitry collects client device haptics feedback and gesture recognition capabilities. For example, a client device may receive data from a haptic device comprising five pressure sensors and five actuators. In some embodiments, at 1012, control circuitry inspects the received XR content and checks if required neural networks are locally available to support interaction. The received XR content may comprise an XR environment displayed by an XR application. In some implementations, at 1014, control circuitry requests the neural networks, from local cache of neural networks 1010 for gesture recognition and haptics rendering, to support interactions from the interaction server. Control circuitry may request at least one neural network, e.g., neural networks 128 and/or 506.

In some embodiments, at 1016, control circuitry starts XR experience execution. For example, the XR application causes for display the XR environment at the client device. In some implementations, at 1018, control circuitry captures device sensor input. At 1020, control circuitry executes gesture recognition with the neural networks using captured input from the gesture recognition-capable devices and generates output haptics feedback by the neural networks to the haptics feedback devices. Control circuitry may use techniques described in connection with FIGS. 1A-1B, 2, 5, and 8. In some implementations, at 1022, control circuitry processes scene logic based on user input and detected gestures. Control circuitry may use techniques described in connection with FIGS. 1A-1B, 2, 5, and 8. In some embodiments, at 1024, control circuitry renders graphics and haptics and outputs to the display and haptics feedback devices. For example, control circuitry provides haptic feedback to the haptic feedback device associated with the client device according to the control data generated by the neural networks. In some implementations, at 1026, control circuitry determines whether the end of processing is requested. If control circuitry determines that the end of processing is not requested, control circuitry may revert to 1018. If control circuitry determines that the end of processing is requested, control circuitry may proceed to 1028 and end the process.

FIG. 11 is a flowchart of an illustrative process for rendering haptics for haptic feedback devices based on sensor input data, in accordance with some embodiments of this disclosure. In various embodiments, the individual steps of process 1100 may be implemented by one or more components of the devices and systems of FIGS. 1-7 and may be performed in combination with any of the other processes and aspects described herein. Although the present disclosure may describe certain steps of process 1100 (and of other processes described herein) as being implemented by certain components of the devices and systems of FIGS. 1-7, this is for purposes of illustration only. It should be understood that other suitable components of the devices and systems may implement those steps instead.

In some embodiments, at 1102, process 1100 starts. In some implementations, at 1104, control circuitry (e.g., control circuitry 604 of user equipment 600 and/or control circuitry 711 of server 704) requests XR content from the content server. At 1106, control circuitry may transmit the request for the XR content to a local cache of XR experience data. In some implementations, at 1108, control circuitry collects client device haptics feedback and gesture-recognition capabilities. For example, a client device may receive data from a haptic device comprising five pressure sensors and five actuators. In some embodiments, at 1112, control circuitry inspects the received XR content and checks if required neural networks are locally available to support interaction. The received XR content may comprise an XR environment displayed by an XR application. In some implementations, at 1114, control circuitry requests the neural networks, from local cache of neural networks 1110 for gesture recognition and haptics rendering, to support interactions from the interaction server. Control circuitry may request at least one neural network, e.g., neural networks 128 and/or 506.

In some embodiments, at 1116, control circuitry starts XR experience execution. For example, the XR application causes for display the XR environment at the client device. In some implementations, at 1118, control circuitry captures device sensor input. In some embodiments, at 1120, control circuitry observes if user location/state enables activation of haptics-supported, gesture-based interaction. Control circuitry may use techniques as described in connection with FIGS. 1A-1B and 2 at 1120. If control circuitry observes that the user location/state does not enable activation of haptics-supported, gesture-based interaction, control circuitry may proceed to 1126. If control observes that the user location/state does enable activation of haptics-supported, gesture-based interaction, control circuitry may proceed to 1122. In some implementations, at 1122, control circuitry loads neural networks required for the interaction to the device RAM if the neural networks are not yet loaded. At 1124, control circuitry executes gesture recognition with the neural networks using captured input from the gesture detection-capable devices and outputs haptics feedback generated by the neural networks to the haptics feedback devices.

In some implementations, at 1126, control circuitry determines whether the user location/state enables inactivation of previously active haptics-supported, gesture-based interaction. Control circuitry may use techniques as described in connection with FIGS. 1A-1B and 2 at 1126. If control circuitry observes that the user location/state does not enable inactivation of the previously active haptics-supported, gesture-based interaction, control circuitry may proceed to 1130. If control circuitry observes that the user location/state does enable inactivation of the previously active haptics-supported, gesture-based interaction, control circuitry may proceed to 1128. In some embodiments, at 1128, control circuitry removes the neural networks required for the inactivated interaction from the device RAM. At 1130, control circuitry processes scene logic based on user input and detected gestures. Control circuitry may use techniques described in connection with FIGS. 1A-1B, 2, 5, and 8.

In some embodiments, at 1132, control circuitry renders graphics and haptics and outputs to the display and haptics feedback devices. For example, control circuitry provides haptic feedback to the haptic feedback device associated with the client device according to the control data generated by the neural networks. In some implementations, at 1134, control circuitry determines whether the end of processing is requested. If control circuitry determines that the end of processing is not requested, control circuitry may revert to 1118. If control circuitry determines that the end of processing is requested, control circuitry may proceed to 1136 and end the process.

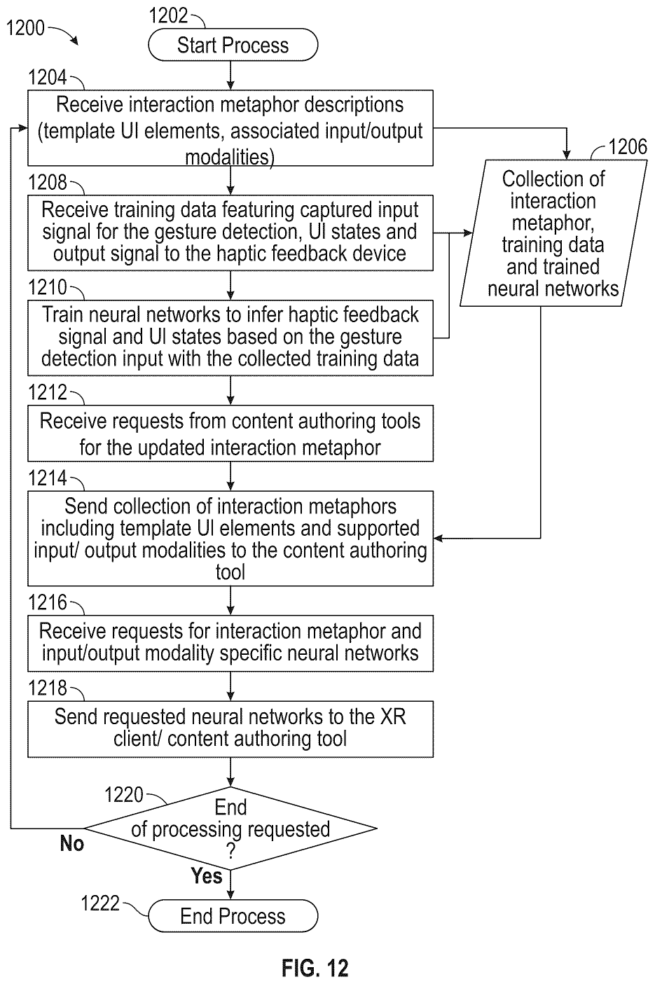

FIG. 12 is a flowchart of an illustrative process for training and receiving neural networks for specific devices of varying haptic capability, in accordance with some embodiments of this disclosure. In various embodiments, the individual steps of process 1200 may be implemented by one or more components of the devices and systems of FIGS. 1-7 and may be performed in combination with any of the other processes and aspects described herein. Although the present disclosure may describe certain steps of process 1200 (and of other processes described herein) as being implemented by certain components of the devices and systems of FIGS. 1-7, this is for purposes of illustration only. It should be understood that other suitable components of the devices and systems may implement those steps instead.

In some embodiments, process 1200 begins at 1202. At 1204, control circuitry (e.g., control circuitry 604 of user equipment 600 and/or control circuitry 711 of server 704) receives interaction metaphor descriptions (e.g., template UI elements and associated input/output modalities). Interaction metaphor descriptions may be e.g., a generic UI element such as generic light switch 110 as described in connection with FIGS. 1A-1B. Collection 1206 comprises template UI elements from which the actual UI element (e.g., virtual light switch 116 of FIG. 1B), used in the run-time of an XR experience, is chosen based on the capabilities of the local device (e.g., user device 114) and/or the haptic device (e.g., haptic device 130). For each template UI element, combinations of haptic feedback and gesture input modalities are listed. The combinations may enable use of the specific template UI element. New interaction metaphors may be added by defining template UI elements and providing training data comprising training samples for performing the gesture recognition for gesture recognition devices and desired haptics output for haptic feedback devices. In addition to the initial input, the training data to extend the support of gesture recognition and haptic feedback devices to be supported can be added cumulatively during the run-time operation of the interaction server

In some embodiments, at 1208, control circuitry receives training data featuring a captured input signal for the gesture detection, UI states, and an output signal to the haptic feedback device. The initial training data may be collected by harvesting the data from existing methods that feature haptics-supported, gesture-based interaction without the adaptation. In some implementations, training data serving as initial training data is collected by capturing the input signals from the gesture detection device and capturing associated output signals created for the haptic feedback device. Control circuitry may capture the interaction metaphor and UI state by inspecting the XR experience state by detecting the graphics output of the XR experience.

In some implementations, at 1210, control circuitry trains the neural networks to infer haptic feedback signals and UI states based on the gesture-detection input with the collected training data. Control circuitry may train the neural networks using techniques described in connection with FIGS. 1A-1B, FIG. 2, and/or FIG. 5. In some embodiments, control circuitry inputs the interaction metaphor descriptions received at 1204, the training data received at 1208, and the trained neural networks received at 1210 into a collection of interaction metaphors, training data, and trained neural networks (e.g., collection 1206). In some implementations, at 1212, control circuitry receives requests from content authoring tools for the updated interaction metaphors. Content authoring tools may be a design system such as Unity or Unreal Engine. The design system may request updated generic UI elements from control circuitry.

In some embodiments, at 1214, control circuitry sends collection 1206 to the content authoring tool. Control circuitry may transmit the data of collection 1206 to a design device running the design system. In some implementations, at 1216, control circuitry receives requests for an interaction metaphor and neural networks specific to an input/output modality. For example, a designer using the design system, via a design UI interaction, requests a generic virtual light switch and neural networks trained for its respective input/output modalities (e.g., turning on and off and/or dimming). In some embodiments, at 1218, control circuitry sends the requested neural networks to the XR client/content authoring tool. Control circuitry transmits at least one neural network to the user device and/or design device. In some implementations, at 1220, control circuitry determines whether the end of processing is requested. If control circuitry determines that the end of processing is not requested, control circuitry may revert to 1204. If control circuitry determines that the end of processing is requested, control circuitry may proceed to 1222 and end the process.

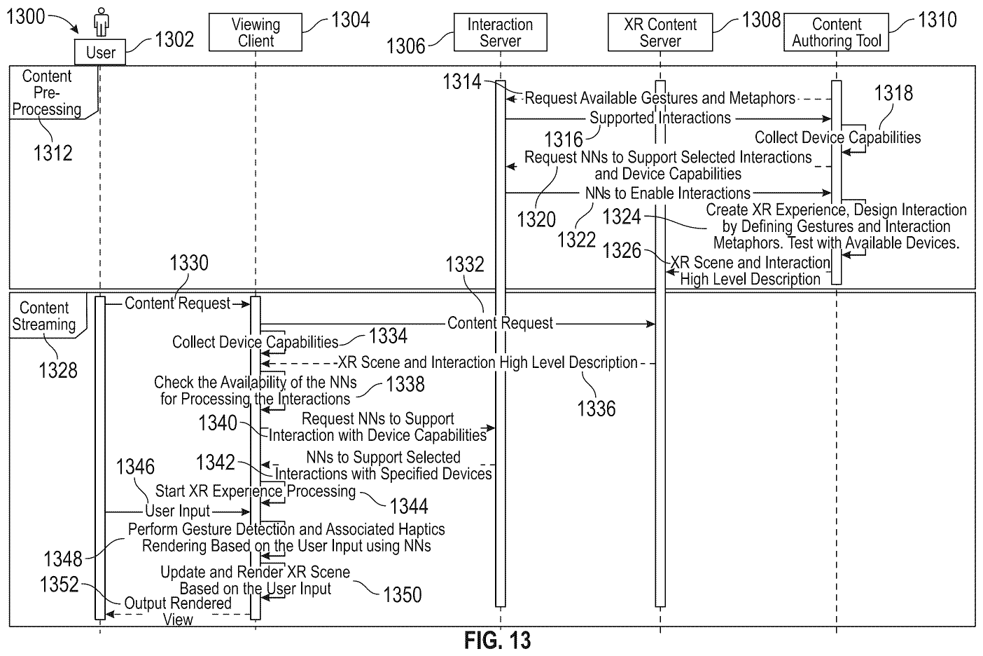

FIG. 13 is a sequence diagram of an illustrative process for processing gesture recognition data and rendering haptic feedback, in accordance with some embodiments of this disclosure. In various embodiments, the individual steps of process 1300 may be implemented by one or more components of the devices and systems of FIGS. 1-7 and may be performed in combination with any of the other processes and aspects described herein. Although the present disclosure may describe certain steps of process 1300 (and of other processes described herein) as being implemented by certain components of the devices and systems of FIGS. 1-7, this is for purposes of illustration only. It should be understood that other suitable components of the devices and systems may implement those steps instead.

In some embodiments, at 1312, interaction server 1306, XR content server 1308, and content authoring tool 1310 communicate with each other for content pre-processing. At 1314, in some implementations, content authoring tool 1310 (e.g., a design system) requests available gestures and metaphors from interaction server 1306. A metaphor may be a generic UI element or placeholder, such as generic light switch 110 as described in connection with FIGS. 1A-1B. In some embodiments, at 1316, interaction server 1306 transmits data of supported interactions to content authoring tool 1310. In some implementations, at 1318, content authoring tool 1310 collects data of device capabilities. Control circuitry may use techniques as described in connection with FIG. 2.

In some embodiments, at 1320, content authoring tool 1310 requests, from interaction server 1306, at least one neural network to support selected interactions and device capabilities. At 1322, interaction server 1306 transmits the at least one neural network to content authoring tool 1310 to enable interactions. In some embodiments, at 1324, content authoring tool 1310 creates an XR experience and design interaction by defining gestures and interaction metaphors. Content authoring tool 1310 may also test the gestures and interaction metaphors with available devices. In some implementations, at 1326, content authoring tool 1310 transmits an XR scene of the XR experience and interaction high-level description to XR content server 1308. In some embodiments, at 1328, user 1302, viewing client 1304, interaction server 1306, and XR content server 1308 communicate with each other for content streaming. At 1330, in some implementations, user 1302 requests content from viewing client 1304. In some embodiments, at 1332, viewing client 1304 requests content from XR content server 1308. In some implementations, at 1334, viewing client 1304 collects data of device capabilities.

In some embodiments, at 1336, XR content server 1308 transmits the XR scene and interaction high-level description to viewing client 1304. In some implementations, at 1338, viewing client 1304 checks the availability of the at least one neural network for processing the interactions. At 1340, viewing client 1304 requests the at least one neural network to support interaction with device capabilities from interaction server 1306. In some implementations, at 1342, interaction server 1306 transmits, to viewing client 1304 the at least one neural network to support selected interactions with specified devices. In some embodiments, at 1344, viewing client 1304 starts XR experience processing. In some implementations, at 1346, user 1302 transmits a user input to viewing client 1304. At 1348, viewing client 1304 performs gesture detection and associated haptics rendering based on the user input using the at least one neural network. In some implementations, at 1350, viewing client 1304 updates and renders the XR scene based on the user input. In some embodiments, at 1352, viewing client 1304 outputs the rendered view to user 1302.

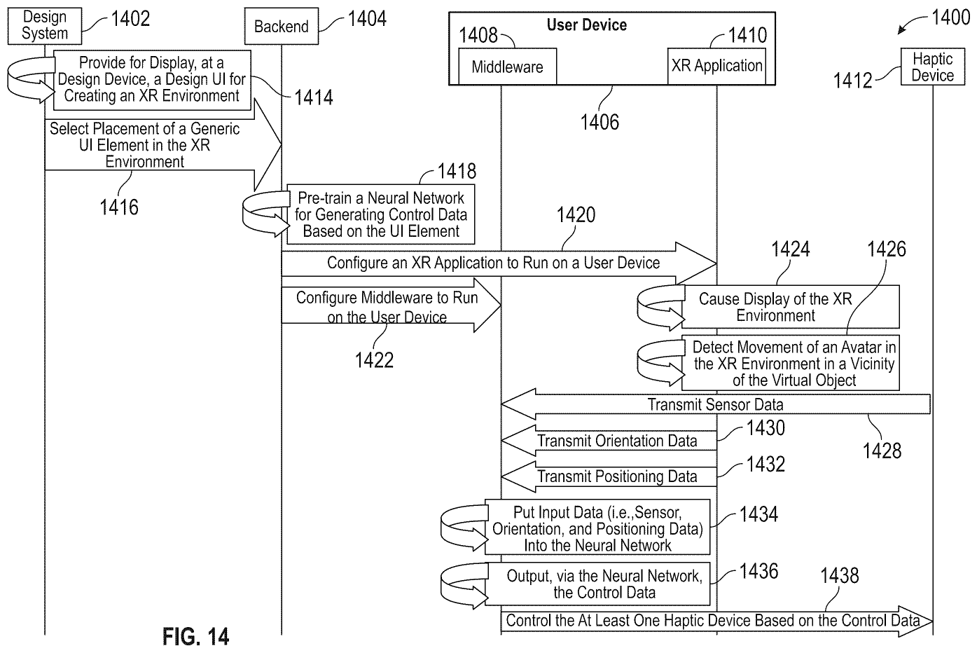

FIG. 14 is a sequence diagram of an illustrative process for configuring middleware to control a haptic device using a neural network, in accordance with some embodiments of this disclosure. In various embodiments, the individual steps of process 1400 may be implemented by one or more components of the devices and systems of FIGS. 1-7 and may be performed in combination with any of the other processes and aspects described herein. Although the present disclosure may describe certain steps of process 1400 (and of other processes described herein) as being implemented by certain components of the devices and systems of FIGS. 1-7, this is for purposes of illustration only. It should be understood that other suitable components of the devices and systems may implement those steps instead.

In some embodiments, design system 1402, at 1414, provides for display, at a design device, a design UI for creating an XR environment. For example, a design device displays a design UI (e.g., design device 100 and design UI 102 as described in connection with FIG. 1A) comprising a plurality of generic UI elements and a plurality of virtual objects. Design system 1402 may be used to design, e.g., XR environment 112 as described in connection with FIG. 1B. In some implementations, at 1416, design system 1402 selects placement of a generic UI element in the XR environment. For example, design system 1402 inserts a virtual box (e.g., generic light switch 110) as a placeholder UI element near a wall within XR environment 112. In some embodiments, a backend system (e.g., backend 1404), at 1418, pre-trains a neural network for generating control data based on the UI element. Backend 1404 may pre-train, e.g., neural network 128 or neural network 506 using techniques described in connection with FIGS. 1A-1B and FIG. 5.

In some implementations, at 1420, backend 1404 configures an XR application (e.g., XR application 1408) to run on a user device (e.g., user device 1406). For example, backend 1404 configures a video game application to run on user device 1406. In some embodiments, at 1422, backend 1404 configures middleware (e.g., middleware 1408) to run on user device 1406. Middleware 1408 may be configured, by backend 1404, to control at least one haptic device (e.g. haptic device 1412) using the neural network. In some implementations, at 1424, XR application 1410 causes display of the XR environment. For example, the video game XR application displays, at a UI of user device 114, a virtual office environment (e.g., XR environment 112 as described in connection with FIGS. 1A-1B). In some embodiments, at 1426, XR application 1410 detects movement of an avatar in the XR environment in a vicinity of the virtual object. XR application 1410 may detect the movement of the avatar using techniques described in connection with FIG. 8.

In some implementations, at 1430, haptic device 1412 transmits sensor data to middleware 1408. For example, haptic device 1412 may transmit, e.g., pose sensor data 124 as described in connection with FIG. 1B to middleware 1408. In some embodiments, at 1430, XR application 1410 transmits orientation data to middleware 1408. For example, XR application 1410 may transmit, e.g., avatar time series data 120 as described in connection with FIG. 1B to middleware 1408. In some implementations, at 1432, XR application 1410 transmits positioning data to middleware 1408. For example, XR application 1410 may transmit, e.g., UI element location data 122 as described in connection with FIG. 1B to middleware 1408. In some embodiments, at 1434, middleware 1408 puts input data (i.e., the sensor, orientation, and positioning data) into the neural network. In some implementations, at 1436, middleware 1408 outputs, via the neural network, the control data. The neural network may generate the control data using techniques described in connection with FIGS. 1A-1B and FIG. 5. In some embodiments, at 1438, middleware 1408 controls haptic device 1412 based on the control data. Middleware 1408 may control haptic device 1412 based on the control data (for example, instructions for a type of haptic feedback, such as vibration) output from the neural network.

The processes discussed above are intended to be illustrative and not limiting. One skilled in the art would appreciate that the steps of the processes discussed herein may be omitted, modified, combined and/or rearranged, and any additional steps may be performed without departing from the scope of the disclosure. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method comprising:
generating for display a virtual object, within an extended reality (XR) environment, wherein the display is based on at least one generic user interface (UI) element, wherein design of the XR environment is based at least in part on:
providing for display, at a first device, a design user interface for creating the XR environment;
receiving a design user interface selection for placement of the at least one generic UI element in a location in the XR environment, wherein the at least one generic UI element represents a functionality of a real-world object;
configuring an XR application to run on a second device, wherein the XR application causes display of the XR environment;
configuring middleware to run on the second device, wherein the middleware is configured to control at least one haptic device using at least one neural network;
based on detecting movement of an avatar in the XR environment by the XR application in a vicinity of the virtual object, causing the middleware to put input data into the at least one neural network, wherein the input data comprises:
(i) a time series of user pose data received from at least one sensor,
(ii) a time series of orientation data of the avatar received from the XR application, and
(iii) positioning data of the avatar with respect to the virtual object received from the XR application,
wherein the at least one neural network of the middleware outputs control data for controlling the at least one haptic device based at least in part on the input data; and
controlling, by the middleware, the at least one haptic device based on the control data.

2. The method of claim 1, further comprising:
pre-training the at least one neural network for generating the control data based on at least one functional description of the at least one generic UI element.

3. The method of claim 1, further comprising:
configuring a plurality of XR applications to run on a plurality of devices, wherein each XR application of the plurality of XR applications comprises the at least one generic UI element;
receiving, from respective middleware of each device of the plurality of devices running the plurality of XR applications, user interaction data of a plurality of virtual objects corresponding to the at least one generic UI element; and
re-training the at least one neural network for generating the control data based on the received user interaction data.

4. The method of claim 1, wherein the generating for display the virtual object further comprises:
determining, by the middleware, at least one of: (a) a type of sensor, or (b) a type of the at least one haptic device;
transmitting, to the XR application, data comprising the at least one of: (a) the type of sensor, or (b) the type of the at least one haptic device; and
wherein appearance of the virtual object is selected by the XR application based at least in part on the at least one of: (a) the type of sensor, or (b) the type of the at least one haptic device.

5. The method of claim 4, further comprising:
causing the middleware to input, into the at least one neural network, the data comprising the at least one of: (a) the type of sensor, or (b) the type of the at least one haptic device,
wherein the control data output by the at least one neural network is based on the data comprising the at least one of: (a) the type of sensor, or (b) the type of the at least one haptic device.

6. The method of claim 1, further comprising:
selecting the at least one neural network from a plurality of neural networks based on the input data received by the middleware; and
downloading the at least one neural network, via the middleware, to a random-access memory (RAM) of the local device.

7. The method of claim 1, wherein the detecting the movement of the avatar in the XR environment by the XR application in the vicinity of the virtual object further comprises:
detecting movement, by the at least one sensor, of at least one component of the at least one haptic device; and
generating the movement of the avatar, by the XR application, wherein the movement of the avatar corresponds to the movement of the at least one component of the at least one haptic device.

8. The method of claim 1, wherein the detecting the movement of the avatar in the XR environment by the XR application in the vicinity of the virtual object further comprises:
receiving a user interface interaction, via a control of the second device, associated with the avatar; and
generating the movement of the avatar, by the XR application, based on the user interface interaction.

9. The method of claim 1, wherein the controlling, by the middleware, the at least one haptic device based on the control data further comprises:
controlling, by the middleware, at least one actuator of the at least one haptic device,
wherein the at least one actuator generates haptic feedback in at least one component of the at least one haptic device.

10. The method of claim 1, wherein the generating for display the virtual object further comprises:
determining, by the XR application, at least one aesthetic element of the XR environment,
wherein appearance of the virtual object is selected by the XR application based at least in part on the at least one aesthetic element of the XR environment.

11. The method of claim 1, wherein the at least one sensor is at least one of a pressure sensor, temperature sensor, capacitive sensor, resistive sensor, optical camera, RGB-D camera, gyroscope, accelerometer, or flex sensor.

12. The method of claim 1, further comprising:
modifying a haptic feedback complexity of the virtual object based on a number of available sensors, wherein a greater number of available sensors corresponds to a greater haptic feedback complexity.

13. The method of claim 1, further comprising:
modifying a haptic feedback complexity of the virtual object based on a number of available actuators of the at least one haptic device, wherein a greater number of available actuators corresponds to a greater haptic feedback complexity.

14. The method of claim 1, wherein the real-world object is one of a light switch, a steering wheel, or a gear stick.

15. A system comprising:
control circuitry configured to:
generate for display a virtual object, within an extended reality (XR) environment, wherein the display is based on at least one generic user interface (UI) element, wherein design of the XR environment is based at least in part on:
provide for display, at a first device, a design user interface for creating the XR environment;
receive a design user interface selection for placement of the at least one generic UI element in a location in the XR environment, wherein the at least one generic UI element represents a functionality of a real-world object;
configure an XR application to run on a second device, wherein the XR application causes display of the XR environment;
configure middleware to run on the second device, wherein the middleware is configured to control at least one haptic device using at least one neural network;
input/output circuitry configured to:
based on detecting movement of an avatar in the XR environment by the XR application in a vicinity of the virtual object, cause the middleware to put input data into the at least one neural network, wherein the input data comprises:
(i) a time series of user pose data received from at least one sensor,
(ii) a time series of orientation data of the avatar received from the XR application, and
(iii) positioning data of the avatar with respect to the virtual object received from the XR application,
wherein the at least one neural network of the middleware outputs control data for controlling the at least one haptic device based at least in part on the input data; and
wherein the control circuitry is further configured to:
control, by the middleware, the at least one haptic device based on the control data.

16. The system of claim 15, wherein the control circuitry is further configured to:
pre-train the at least one neural network for generating the control data based on at least one functional description of the at least one generic UI element.

17. The system of claim 15, wherein the control circuitry is further configured to:
configure a plurality of XR applications to run on a plurality of devices, wherein each XR application of the plurality of XR applications comprises the at least one generic UI element;
receive, from respective middleware of each device of the plurality of devices running the plurality of XR applications, user interaction data of a plurality of virtual objects corresponding to the at least one generic UI element; and
re-train the at least one neural network for generating the control data based on the received user interaction data.

18. The system of claim 15, wherein the control circuitry is further configured to generate for display the virtual object by:
determining, by the middleware, at least one of: (a) a type of sensor, or (b) a type of the at least one haptic device;
transmitting, to the XR application, data comprising the at least one of: (a) the type of sensor, or (b) the type of the at least one haptic device; and
wherein appearance of the virtual object is selected by the XR application based at least in part on the at least one of: (a) the type of sensor, or (b) the type of the at least one haptic device.

19. The system of claim 18, wherein the control circuitry is further configured to:
cause the middleware to input, into the at least one neural network, the data comprising the at least one of: (a) the type of sensor, or (b) the type of the at least one haptic device,
wherein the control data output by the at least one neural network is based on the data comprising the at least one of: (a) the type of sensor, or (b) the type of the at least one haptic device.

20. The system of claim 15, wherein the control circuitry is further configured to:
select the at least one neural network from a plurality of neural networks based on the input data received by the middleware; and
download the at least one neural network, via the middleware, to a random-access memory (RAM) of the local device.

21-70. (canceled)
